(19) United States
(12) Patent Application Publication
(10) Pub. No.: US 2025/0014588 A1
(43) Pub. Date: Jan. 9, 2025

(54) AUDIO ENHANCEMENT AND OPTIMIZATION OF AN IMMERSIVE AUDIO EXPERIENCE

(71) Applicant: SHURE ACQUISITION HOLDINGS, INC., Niles, IL (US)

(72) Inventors: Christian Yost, Niles, IL (US); Michael Lester, Buena Vista, CO (US); Michael Prosinski, Chicago, IL (US); Justin Sconza, Chicago, IL (US)

(21) Appl. No.: 18/763,719

(22) Filed: Jul. 3, 2024

Related U.S. Application Data
(60) Provisional application No. 63/512,512, filed on Jul. 7, 2023.

(51) Int. Cl. G10L 21/0232; G10L 21/0216; G10L 25/30; G10L 25/57

(52) U.S. Cl. CPC G10L 21/0232; G10L 25/30; G10L 25/57; G10L 2021/02166

(57) ABSTRACT

Techniques are disclosed herein for providing audio enhancement and optimization of an immersive audio experience. Examples may include generating an audio feature set for a transduced audio stream captured in an environment, inputting the audio feature set to a neural network model configured to generate an audio isolation mask associated with the transduced audio stream, and generating isolated audio for the transduced audio stream based at least in part on the audio isolation mask.

### CROSS REFERENCE TO RELATED APPLICATIONS

This application claims the benefit of U.S. Provisional Patent Application No. 63/512,512, titled “AUDIO ENHANCEMENT AND OPTIMIZATION OF AN IMMERSIVE ARENA BASED AUDIO EXPERIENCE,” and filed on Jul. 7, 2023, the entirety of which is hereby incorporated by reference.

### TECHNICAL FIELD

Embodiments of the present disclosure relate generally to audio processing and, more particularly, to systems, methods, and computer program products for enhancing audio signals related to audio environments.

### BACKGROUND

An audio processing system for an audio environment may utilize one or more microphones and digital signal processing to capture, process, and/or transmit audio data associated with the audio environment. However, noise, reverberation, acoustic feedback, and/or other undesirable sound is often introduced during audio capture by an audio processing system for an audio environment.

### BRIEF SUMMARY

Various embodiments of the present disclosure are directed to apparatuses, systems, methods, and computer readable media for providing audio enhancement and optimization of an immersive audio experience. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example audio isolation signal processing system in accordance with one or more embodiments disclosed herein;

FIG. 2 illustrates an example audio isolation signal processing apparatus configured in accordance with one or more embodiments disclosed herein;

FIG. 3 illustrates an example audio system in accordance with one or more embodiments disclosed herein;

FIG. 4 illustrates another example audio system in accordance with one or more embodiments disclosed herein;

FIG. 5 illustrates another example audio system in accordance with one or more embodiments disclosed herein;

FIG. 6 illustrates an example audio isolation signal processing subsystem in accordance with one or more embodiments disclosed herein;

FIG. 7 illustrates another example audio isolation signal processing subsystem in accordance with one or more embodiments disclosed herein;

FIG. 8 illustrates an example pre-processing subsystem in accordance with one or more embodiments disclosed herein;

FIG. 9 illustrates an example post-processing subsystem in accordance with one or more embodiments disclosed herein;

FIG. 10 illustrates an example arena environment associated with an audio isolation signal processing system in accordance with one or more embodiments disclosed herein;

FIG. 11 illustrates an example audio stream and isolated audio in accordance with one or more embodiments disclosed herein;

FIG. 12 illustrates an example system in accordance with one or more embodiments disclosed herein;

FIG. 13 illustrates an example audio processing control user interface in accordance with one or more embodiments disclosed herein;

FIG. 14 illustrates another example audio processing control user interface in accordance with one or more embodiments disclosed herein;

FIG. 15 illustrates another example audio processing control user interface in accordance with one or more embodiments disclosed herein; and

FIG. 16 illustrates an example method for providing audio enhancement and/or optimization of an immersive audio experience in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

Various embodiments of the present disclosure address technical problems associated with accurately, efficiently and/or reliably isolating audio associated with an audio environment such as, for example, an arena environment. Noise, reverberation, acoustic feedback, and/or other undesirable audio are often introduced during audio capture operations related to microphones located in an audio environment. For arena environments, such noise, reverberation, acoustic feedback, and/or other undesirable audio affect quality of broadcast audio, broadcast video, and/or speech reinforcement associated with an arena environment, which may produce an undesirable audio experience for listeners. For example, when microphones are placed in an arena environment intended for a television or radio broadcast, the desired audio may be voice audio related to an athlete speaking to a coach and/or other non-speech sporting event noises such as a squeak of shoes worn by the athlete, bouncing of a basketball on a basketball court, the “swish” of a basketball passing through a net, and the like. However, an arena environment typically includes other audio such as, for example, sound waves from a public address (PA) announcer, audio advertisements and announcements, music, spectator sounds (e.g., crowd noise), and/or other sounds emanating from the arena environment.

Various examples disclosed herein provide isolated audio and/or improved audio signal quality for audio captured in an audio environment via machine learning. The audio isolation signal processing system may be additionally or alternatively configured for enabling a user to modify, control, and/or fine-tune isolated audio associated with an audio environment. As such, enhanced audio for an audio environment may be provided.

### Example Audio Isolation Signal Processing Systems

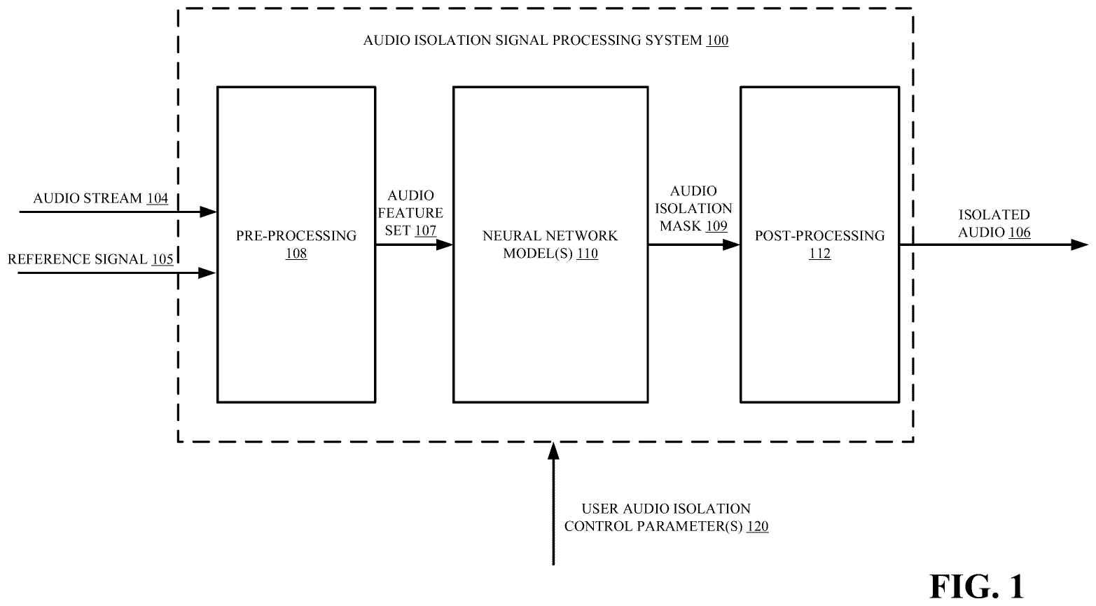

FIG. 1 illustrates an audio isolation signal processing system 100 that is configured to provide audio enhancement and/or optimization of an immersive audio experience (e.g., an immersive arena based audio experience), according to embodiments of the present disclosure. In various examples, the audio isolation signal processing system 100 provides isolated audio and/or improved audio signal quality for audio captured in an audio environment. The isolated audio may also enable removing and/or suppressing noise, reverberation, acoustic feedback, and/or other undesirable characteristics associated with audio captured in an audio environment. In some examples, the isolated audio may correspond to desirable audio for broadcast audio, broadcast video, and/or speech reinforcement. In some examples, the audio isolation signal processing system 100 may be an arena audio signal processing system for an arena environment.

The immersive audio experience may be provided in an audio environment such as, but not limited to, an arena environment. The audio environment may be an indoor environment or an outdoor environment. In some examples, the audio enhancement and/or optimization of the immersive audio experience utilizes output from one or more neural network models trained based on an audio feature set extracted from an audio stream captured in the audio environment. Additionally or alternatively, the audio enhancement and/or optimization of the immersive audio experience utilizes output from an audio mixer (e.g., an automixer) and/or a voice activity detector applied to the audio stream.

The disclosed techniques for the audio isolation signal processing system 100 may be implemented for an audio environment such as, but not limited to, an arena environment to capture audio signal streams, isolate the audio signal streams based on class and/or locality, select desired audio classes and/or locales, and generate an immersive audio stream that is configured for output via television broadcast, audio streaming, video streaming, a speech reinforcement system, or other media service. As described herein, an arena environment may refer to any building, venue, facility, or space comprising a playing region (or performance region) as well as a spectator region. In some examples, an arena environment may further include a noise source region.

An arena environment may be an audio environment for a live event and/or a broadcast related to sports, entertainment, music, theater, a presentation, and/or another type of audio application. Additionally, an arena environment may be an indoor audio environment or an outdoor audio environment. In a non-limiting example, an arena environment may include: an indoor sporting arena (e.g., sports stadium or arena, basketball arena, football stadium, hockey stadium, soccer stadium, boxing arena, or the like); an indoor entertainment arena (e.g., concert hall, theater, auditorium, or the like); an outdoor stadium environment (e.g., an outdoor football stadium, an outdoor baseball stadium, a soccer stadium, a concert venue, or the like); an outdoor sporting event (e.g., an outdoor basketball court, an outdoor extreme sports competition, or the like), a broadcasting environment, or another similar environment in which audio signal streams are captured to create and provide an immersive audio experience. However, although the present disclosure is described with respect to an arena environment for purposes of illustration, it is to be appreciated that the present disclosure is not limited to arena environments.

A playing region refers to a portion of an arena environment in which performers are designated to perform. A playing region may include: a basketball playing surface, a football field, an ice surface of a hockey stadium, a field area of a soccer field, a field area of a baseball field, a stage of an entertainment arena (e.g., a concert hall, theater, or the like), or another similar participant region of an arena environment. A noise source region refers to a portion of an arena environment from which additional sound waves (e.g., in addition to the playing region) may emanate. In some examples, a noise source region may include: sound waves from a public address (PA) announcer, audio advertisements and announcements, music, spectator sounds (e.g., crowd noise), and/or other sounds emanating from the arena environment.

Some flawed approaches to producing an immersive audio experience involve positioning numerous static, directional, and analog microphones around an arena environment. The imperfect directionality of these microphones allows unwanted sounds (such as music, PA audio, spectator sounds, etc.) to be included in the output audio stream.

In addition, if a broadcast television producer desires to capture audio in new directions or from another source, the directional microphones must be manually moved by an operator. Manual movement of directional microphones is also required when the target source of the audio capture moves around the arena environment. This may be particularly problematic in large arena environments such as football stadiums, soccer stadiums, baseball stadiums, and the like.

Capturing sufficient localized audio signal streams to create an immersive experience using directional microphones also requires many directional microphones and accompanying cabling to point to the various areas of interest in an arena environment. Finally, in-game audio produced from directional microphones must be manually mixed by an engineer by selecting specific audio sources to enable and disable, which may be difficult to execute during a live broadcast.

The audio isolation signal processing system 100 may be utilized to overcome the aforementioned drawbacks and more by creating an immersive audio experience by selection and placement of sound wave capture devices (e.g., 1.5D microphone arrays, 2D linear and planar microphone arrays, 3D surface arrays of microphones, and 3D suspended arrays of microphones) in conjunction with traditional omnidirectional and unidirectional audio capture devices. A 1.5D microphone array is a microphone array configured to provide a one-dimensional form factor that, in some embodiments, has added directivity, for most, if not all, frequencies, in dimensions that, conventionally, have equal sensitivity in all directions as discussed in greater detail in commonly owned U.S. Pat. No. 11,297,426, titled “One-Dimensional Array Microphone with Improved Directivity,” and issued on Apr. 5, 2022, which is hereby incorporated by reference in its entirety.

The audio isolation signal processing system 100 further provides for processing of audio signal streams to improve audio quality through artificially intelligent (AI) audio isolation, denoising, acoustic echo cancellation, and/or speech removal. Example techniques further provide for identification and classification of audio sources, localization of captured audio signal streams, and selection and generation of an immersive audio stream. Accordingly, the audio isolation signal processing system 100 may be utilized to overcome technical problems associated with capturing, processing, and/or generating audio signal streams (e.g., collection of audio data) associated with an arena environment to provide an immersive audio experience for a remote spectator of a sporting event or other performance.

The audio isolation signal processing system 100 may utilize various capture devices to capture an audio signal stream from an arena environment. For example, multi-lobe capture devices may be configured to define beamformed lobes based on locality. Utilizing multi-lobe capture devices to define beamformed lobes provides coverage of a wide area while still allowing focused selection of specific regions of interest. In some examples, a multi-lobe capture device may be a steerable digital sound wave capture device or a switchable digital sound wave capture devices configured with multiple beamformed lobes. Use of multi-lobe capture devices also provide for enhanced audio region selectivity while minimizing the number of needed audio capture devices by selectively updating the audio capture area based on the desired immersive audio experience.

In various examples, the audio isolation signal processing system 100 is configured to use advanced audio processing techniques, such as separation and classification of audio sources, to further classify and focus the captured audio streams. For example, in circumstances where an arena environment includes a basketball court, the audio isolation signal processing system 100 may utilize one or more machine learning models and/or an AI module disposed in a digital signal processing chain to classify an audio signal stream source as voice, conversation, ball sounds, player exclamations, or PA sounds. Similarly, in circumstances where an arena environment includes a baseball field, the one or more machine learning models and/or AI module of the audio isolation signal processing system 100 may classify the crack of the bat, the slap of the glove, exclamations from the dugout, or other sounds that may contribute to the overall spectator experience.

The audio isolation signal processing system 100 may additionally suppress certain types of noise in an audio environment while still allowing other types of noises to pass through an audio channel. For example, noise created by spectators and/or a sound reinforcement system at a sporting event may be suppressed while still allowing natural sounds from the sporting event to pass though audio channels. In some examples, the audio isolation signal processing system 100 may utilize one or more machine learning models to isolate desired sports sounds from undesired crowd and stadium sounds.

Insights from the one or more machine learning models may be utilized to: enhance audio for arena environments, control and/or optimize an audio system through feedback from the one or more AI models, optimize audio characteristics of individual channels to allow to provide an optimal audio mixture for a broadcast or a sound reinforcement scenario related to a sporting event or another type of event in an arena environment. In some examples, an immersive audio experience for a remote spectator may be additionally or alternatively created by virtually positioning the remote spectator within a particular region of an arena environment (e.g., a playing region, a spectator region, playing region adjacent area, etc.) while also optimizing the audio experience (e.g., amplifying or enhancing preferred sounds while filtering or removing undesirable sounds) for the particular region of the arena environment.

The audio isolation signal processing system 100 is configured to perform at least audio isolation, denoising, speech removal, and/or other filtering of sound with respect to an audio stream 104 to provide isolated audio 106. In some examples, the isolated audio 106 is isolated arena audio associated with an arena environment. In some examples, the audio isolation signal processing system 100 is configured as an intelligent DSP system configured to perform at least audio isolation, denoising, speech removal, and/or other filtering of sound with respect to the audio stream 104 via digital signal processing and/or machine learning. In some examples, the audio isolation signal processing system 100 is an intelligent digital signal processor configured to perform at least audio isolation, denoising, speech removal, and/or other filtering of sound with respect to the audio stream 104 via digital signal processing and/or machine learning.

The audio stream 104 may include one or more microphone signals. In some examples, the audio stream 104 may include one or more commentator microphone signals, one or more arena sound microphone signals, and/or one or more reference microphone signals. Additionally, the audio stream 104 may be captured via one or more capture devices within an arena environment. The one or more capture devices may include one or more sensors configured for capturing audio by converting sound into one or more electrical signals. The audio captured by the one or more capture devices may also be converted into the audio stream 104 (e.g., the commentator microphone signal, the one or more arena sound microphone signals, and/or the reference microphone signal). The audio stream 104 may be digital audio or, alternatively, analog audio. In some examples, the audio stream 104 is a transduced audio stream generated via one or more transducer capture devices such as, for example, one or more linear array sound wave capture devices. In some examples, the audio isolation signal processing system 100 may receive the audio stream 104 from an audio mixer device.

In some examples, the audio isolation signal processing system 100 may utilize a reference signal 105 to perform audio isolation, denoising, speech removal, and/or other filtering of sound with respect to the audio stream 104. However, it is to be appreciated that the audio isolation signal processing system 100 may be executed with or without the reference signal 105 based on the particular implementation of the audio isolation signal processing system 100. The reference signal 105 may be a reference microphone signal associated with the audio environment. For example, the reference signal 105 may be associated with a known point source of audio such as, for example, PA audio in the arena environment. In some examples, the reference signal 105 may be utilized to further improve noise isolation and/or noise cancellation for a commentator microphone signal and/or the one or more arena sound microphone signals. In some examples, the reference signal 105 is a reference audio signal that drives a sound reinforcement system (e.g., a PA sound reinforcement system) in an arena environment.

In an example, the one or more capture devices associated with the audio stream 104 are one or more microphones. For example, the one or more capture devices may correspond to one or more condenser microphones, one or more micro-electromechanical systems (MEMS) microphones, one or more dynamic microphones, one or more piezoelectric microphones, one or more array microphones, one or more beamformed lobes of an array microphone, one or more linear array microphones, one or more ceiling array microphones, one or more table array microphones, one or more virtual microphones, one or more network microphones, one or more ribbon microphones, or another type of microphone configured to capture audio. In some examples, the one or more capture devices include a plurality of multi-lobe capture devices. However, it is to be appreciated that, in certain examples, the one or more capture devices may additionally or alternatively include one or more video capture devices, one or more infrared capture devices, one or more sensor devices, and/or one or more other types of audio capture devices.

The one or more capture devices may be positioned at one or more locations within the arena environment. For example, the one or more capture devices may be positioned within the arena environment and may be configured to direct one or more first beamformed lobes to a playing region of the arena environment, one or more second beamformed lobes to a spectator region of the arena environment, and one or more third beamformed lobes to a noise source region of the arena environment.

In some examples, the audio isolation signal processing system 100 generates an audio feature set 107 for the audio stream 104 captured in the arena environment. The audio feature set 107 may be a model input audio feature set for one or more neural network models 110 utilized by the audio isolation signal processing system 100 for providing audio isolation, denoising, speech removal, and/or other filtering of sound with respect to an audio stream 104. In some examples, the audio feature set 107 includes one or more audio features for the one or more microphone signals associated with the arena environment. Additionally, the audio feature set 107 may represent physical features and/or perceptual features related to the one or more microphone signals associated with the arena environment. For instance, the audio feature set 107 may comprise: one or more: audio spectrum features, magnitude features, phase features, pitch features, harmonic features, Mel-frequency cepstral coefficients (MFCC) features, performance features, performance sequencer features, tempo features, time signature features, and/or other types of features associated with the one or more microphone signals associated with the arena environment.

The audio spectrum features represent physical features of the audio stream 104 such as frequency characteristics and/or distribution of energy measurements with respect to the audio stream. The magnitude features may represent physical features of the audio stream 104 such as magnitude measurements with respect to the audio stream 104. The phase features may represent physical features of the audio stream 104 such as phase measurements with respect to the audio stream 104. The pitch features may represent perceptual features of the audio stream 104 such as frequency characteristics related to pitch for the audio stream 104. The harmonic features may represent perceptual features of the audio stream 104 such as frequency characteristics related to harmonics for the audio stream 104.

The MFCC features may represent physical features of the audio stream 104 such as MFCC measurements with respect to the audio stream 104. The MFCC measurements may be extracted based on windowing operations, digital transformations, and/or warping of frequencies on a Mel frequency scale with respect to the audio stream 104.

The performance features may represent perceptual features of the audio stream 104 such as audio characteristics related to performance of the audio stream 104. In some examples, the performance features may be obtained via one or more audio analyzers that analyze performance of the audio stream 104. The performance sequencer features may represent perceptual features of the audio stream 104 such as audio characteristics related to performance of the audio stream 104 as determined by one or more audio sequencers that analyze characteristics of the audio stream 104.

The tempo features may represent perceptual features of the audio stream 104 such as beats per minute characteristics related to tempo for the audio stream 104. The time signature features may represent perceptual features of the audio stream 104 such as beats per musical measure characteristics related to a time signature for the audio stream 104.

In some examples, the audio isolation signal processing system 100 applies pre-processing 108 to the audio stream 104. In some examples, the audio isolation signal processing system 100 may apply respective pre-processing 108 to respective microphone signals. The pre-processing 108 may generate one or more portions of the audio feature set 107. For example, the pre-processing 108 may perform one or more feature extraction techniques with respect to the audio stream 104 to generate one or more portions of the audio feature set 107.

In some examples, the audio feature set 107 is input to the one or more neural network models 110. The audio isolation signal processing system 100 may include the one or more neural network models 110. Alternatively, the audio isolation signal processing system 100 may be communicatively coupled the one or more neural network models 110. The one or more neural network models 110 may be configured to determine at least one audio isolation mask 109 associated with the audio stream 104. In some examples, the at least one audio isolation mask 109 may include: a denoiser mask, a speech removal mask, a signal of interest mask, and/or another type of audio mask associated with the audio stream 104. For example, the one or more neural network models 110 may determine a denoiser mask, a speech removal mask, and/or a signal of interest mask for the one or more arena sound microphone signals. Additionally or alternatively, the one or more neural network models 110 may determine a denoiser mask for the commentator microphone signal and/or reference microphone signal.

An audio isolation mask may be a neural network mask that isolates one or audio portions of the audio stream 104 with respect to one or more other audio portions of the audio stream 104. A denoiser mask may be a neural network mask that is utilized to remove undesirable noise from the audio stream 104. A speech removal mask may be a neural network mask that is utilized to remove undesirable speech from the audio stream 104. A signal of interest mask may be a neural network mask that is utilized to isolate one or more signals of interest from the audio stream 104. In some examples, a signal of interest may include sporting event audio such as voice audio related to an athlete speaking to a coach and/or other non-speech sporting event noises such as a squeak of shoes worn by the athlete, bouncing of a basketball on a basketball court, the “swish” of a basketball passing through a net, and the like.

In some examples, the audio isolation signal processing system 100 applies the at least one audio isolation mask 109 to the audio stream 104 to generate the isolated audio 106. The isolated audio 106 may include: an isolated commentator's voice, isolated game sounds (e.g., a squeak of shoes worn by the athlete, bouncing of a basketball on a basketball court, etc.), an isolated referee's voice, and/or other isolated arena audio related to the arena environment. The isolated audio 106 may be output via one or more audio output devices. In some examples, the isolated audio 106 may be utilized as speech reinforcement and/or broadcast audio related to arena environment. In some examples, the isolated audio 106 may be correlated with a target video stream associated with the arena environment (e.g., a video stream associated with a sporting event, etc.).

In some examples, the isolated audio 106 may be mono audio. Alternatively, the isolated audio 106 may be spatial audio. For spatial audio implementations, the audio stream 104 received by the audio isolation signal processing system 100 may include multiple channels and multiple audio isolation masks may be accordingly created. In some examples, the multiple channels may be designated to create a spatial audio sound field (e.g., stereo, 5.1 surround sound, Atmos® surround sound, etc.) for the arena environment.

In some examples, the at least one audio isolation mask 109 may be utilized to determine a direction for steering one or more beamformed lobes for one or more capture devices to improve signal-to-noise ratio (SNR) for audio signals. To optimize beam steering, two or more crowd canceller operations may be performed with respect to two or more beamformed lobes steered in different directions. In some examples, a beamformed lobe with highest SNR may be determined as closer to a desired sound (and/or further away from an undesired sound). At a next iteration for beam steering, the delta in steering directions may be unchanged and beam steering may be centered with respect to the direction of the higher SNR signal from the previous iteration for beam steering. As such, one or more beamformed lobes may be steered over time to optimize SNR.

In some examples, the at least one audio isolation mask 109 may be utilized to control selection of an audio channel associated with desirable audio. The desirable audio may be isolated audio such as, but not limited to, an isolated commentator's voice, isolated game sounds (e.g., a squeak of shoes worn by the athlete, bouncing of a basketball on a basketball court, etc.), an isolated referee's voice, and/or other isolated arena audio related to the arena environment. In some examples, the audio isolation signal processing system 100 may initiate selection of an audio channel associated with desirable audio based on the audio isolation mask 109. The audio channel may be selected from a plurality of audio channels associated with an audio mixer (e.g., an automixer).

In some examples, the audio isolation signal processing system 100 generates a reference audio feature set for the reference signal 105. Additionally, the audio isolation signal processing system 100 may input the audio feature set and the reference audio feature set to the one or more neural network models 110 to generate the audio isolation mask 109.

In some examples, the audio isolation signal processing system 100 applies post-processing 112 to the at least one audio isolation mask 109 and/or other data provided by the one or more neural network models 110 to generate the isolated audio 106. In some examples, the audio isolation signal processing system 100 additionally or alternatively applies post-processing 112 to the isolated audio 106 to generate output data. The output data may be generated for an output device. For example, the output device may be an audio mixer device, a DSP processing device, a smartphone, a tablet computer, a laptop, a personal computer, an audio workstation device, a wearable device, an augmented reality device, a virtual reality device, a broadcasting device, a recording device, a microphone, headphones, earphones, speakers, a haptic device, or another type of output device. Additionally, the output data may include: an audio stream, a video stream, broadcast audio, broadcast video, speech reinforcement audio, a control signal, visual data for rendering via an electronic interface, training data for one or more machine learning models, and/or other output data.

In some examples, the audio isolation signal processing system 100 receives one or more user audio isolation control parameters 120 via an electronic interface of a user device. The user device may be a smartphone, a tablet computer, a laptop, a personal computer, an audio workstation device, a wearable device, an augmented reality device, a virtual reality device, or another type of user device that includes one or more displays. The one or more user audio isolation control parameters 120 may be utilized by the one or more neural network models 110 and/or the post-processing 112 to further improve quality and/or control audio characteristics of the isolated audio 106.

In some examples, the audio isolation signal processing system 100 may apply the one or more user audio isolation control parameters 120 to the audio isolation mask 109 to generate a user-modified audio isolation mask. In some examples, a user may control audio isolation associated with the audio stream 104 by determining priority of a goal of the dereverberation. For example, a goal may be to prioritize speech quality, balance, or prioritize removing dereverberation associated with the audio stream 104. In some examples, user priorities may be mapped to a degree of the audio isolation by measuring or approximating the audio qualities of the arena environment based on the reference signal 105. As such, in some examples, the isolated audio 106 may be generated based on the at least one audio isolation mask 109 and the one or more user audio isolation control parameters 120.

In some examples, the post-processing 112 may utilize the one or more user audio isolation control parameters 120 to control an amount and/or ballistics of noise cancellation related to the at least one audio isolation mask 109. In some examples, the one or more user audio isolation control parameters 120 may be generated via one or more user-controlled elements of the electronic interface. In some examples, the one or more user-controlled elements may utilize a set of levels (e.g., low, med, high) to control an amount and/or ballistics of noise cancellation. Alternatively, the one or more user-controlled elements may utilize a dynamic user interface element (e.g., a continuous slider) to control an amount and/or ballistics of noise cancellation. In some examples, the dynamic user interface element may allow a user (e.g., an audio engineer) to achieve improved sound isolation to create a soundtrack portion (e.g., a ‘game sounds FX’ track) of an audio mix. The soundtrack portion may allow punctuation of game sounds or other sounds in an arena environment. Additionally or alternatively, the soundtrack portion may isolate sound with minimal aggression to create a more naturally sounding audio track that may be listened to separate from an audio mixture context while increasing game sound SNR for output audio.

In some examples, the one or more user-controlled elements allows control of an intensity of noise suppression. For example, at higher values, more sound from a crowd may be attenuated. A value may also be set to reduce an amount of suppression from, up to a particular point where no processing is audible. In some examples, the noise suppression may utilize magnitude mask post processing such as performing mask exponentiation to attenuate more (e.g., exponentiation x\hat{ }(greater than 1) or attenuate less (e.g., exponentiation x\hat{ }(less than 1) frequency bands that the one or more neural network models 110 have deemed crowd noise to be removed.

In some examples, the one or more user audio isolation control parameters 120 additionally or alternatively allows control of a rate at which noise (e.g., crowd noise) will be suppressed after an event sound detected. For example, if a noise such as a basketball dribble is detected, the audio isolation signal processing system 100 may be configured with a higher release control to stop suppressing crowd noise for a longer time to let more of the dribbling sound enter an audio channel. In some examples, the release control may include controlling a maximum descent rate (e.g., in dB/s) that an attenuation value is allowed to fall, while specifying a different maximum ascent rate (e.g., in dB/s) that an attenuation value is allowed to rise. As such, by providing an ascent time that is greater than a descent time, a user may tune (e.g., dial in) the level of audio that is passing through temporally and/or may tune the audio to achieve a desired level of ‘naturalness’. In some examples, the release control may include controlling a maximum descent/ascent rate to an absolute descent/ascent rate by allowing the ascent rate to be increased or decreased by a predetermined amount.

In some examples, the arena environment defines a playing region, a spectator region, and a noise source region. Additionally, the audio isolation signal processing system 100 may generate the isolated audio 106 for the playing region, the spectator region, and/or the noise source region based on the audio isolation mask 109 and/or the one or more user audio isolation control parameters 120.

In some examples, the isolated audio 106 may be provided to and/or utilized by audio mixer (e.g., an automixer). In some examples, the audio mixer may generate a spatial audio field for the arena environment. In some examples, the audio mixer may mix one or more portions of the isolated audio 106 with context to desired game sounds or other desired arena sounds. In some examples, the isolated audio 106 may be provided as an input to the audio mixer such that audio being mixed for the arena environment is optimized to desired game sounds or other desired arena sounds.

In some examples, rather than utilizing the one or more neural network models 110, the audio isolation signal processing system 100 may alternatively utilize an audio mixer configured to generate mixed audio output and/or at least one audio isolation mask associated with the audio stream 104 based on an isolated audio quality determination associated with the audio stream 104. In some examples, the at least one audio isolation mask is applied to the mixed audio output to generate the isolated audio 106.

In some examples, the audio isolation signal processing system 100 may process multiple audio channels to allow the multiple audio channels to be mixed together. In some examples, the audio isolation signal processing system 100 may generate mixed isolated audio based on the isolated audio 106 and different isolated audio associated with the arena environment. The different isolated audio may be associated with a different audio channel than the isolated audio 106. Additionally, the audio isolation signal processing system 100 may generate the output data for the output device based at least in part on the mixed isolated audio.

In some examples, the audio isolation signal processing system 100 may be utilized as a side-chain system where audio channels that control mixing decisions for the arena environment are processed by the audio isolation signal processing system 100. Additionally, the resulting control signals can determine which audio signals to select for isolated audio purposes via the audio isolation signal processing system 100. In some examples, the audio isolation signal processing system 100 may receive a first audio channel stream via a first capture device positioned within a first audio capture area of the environment. The first audio capture area may be a playing region, a spectator region, or a noise source region for the arena environment. Additionally, the audio isolation signal processing system 100 may receive a second audio channel stream via a second capture device positioned within a second audio capture area of the environment. The second audio capture area may be a playing region, a spectator region, or a noise source region for the arena environment.

In some examples, the audio isolation signal processing system 100 may generate a first audio feature set for the first audio channel stream and/or generate a second audio feature set for the second audio channel stream. Additionally, the audio isolation signal processing system 100 may input the first audio feature set to a first neural network model to generate a first mixing control signal. The audio isolation signal processing system 100 may also input the second audio feature set to a second neural network model to generate a second mixing control signal. In some examples, the audio isolation signal processing system 100 may select a transduced audio stream (e.g., the audio stream 104) from a plurality of transduced audio streams based on the first mixing control signal and the second mixing control signal. In some examples, the audio isolation signal processing system 100 may select the transduced audio stream (e.g., the audio stream 104) via an audio mixer device.

It is to be appreciated that, the audio isolation signal processing system 100 and/or one or more other aspects disclosed herein may employ fewer of computing resources when compared to traditional audio processing systems that are used for digital signal processing. Additionally or alternatively, the audio isolation signal processing system 100 and/or one or more other aspects disclosed herein may be configured to deploy a smaller number of memory resources allocated to audio isolation, dereverberation, denoising, and/or other audio filtering for an audio signal sample such as, for example, one or more portions of the audio stream 104. In still other examples, the audio isolation signal processing system 100 and/or one or more other aspects disclosed herein may be configured to improve processing speed of audio isolation operations, dereverberation operations, denoising operations, and/or audio filtering operations. The audio isolation signal processing system 100 and/or one or more other aspects disclosed herein may also be configured to reduce a number of computational resources associated with applying machine learning models such as, for example, the one or more neural network models 110, to the task of audio isolation, dereverberation, denoising, and/or other audio filtering. These improvements enable, in some examples, for an improved audio processing systems to be deployed in an arena system or other hardware/software configurations associated with an arena environment where processing and memory resources are limited, and/or where processing speed and efficiency is important.

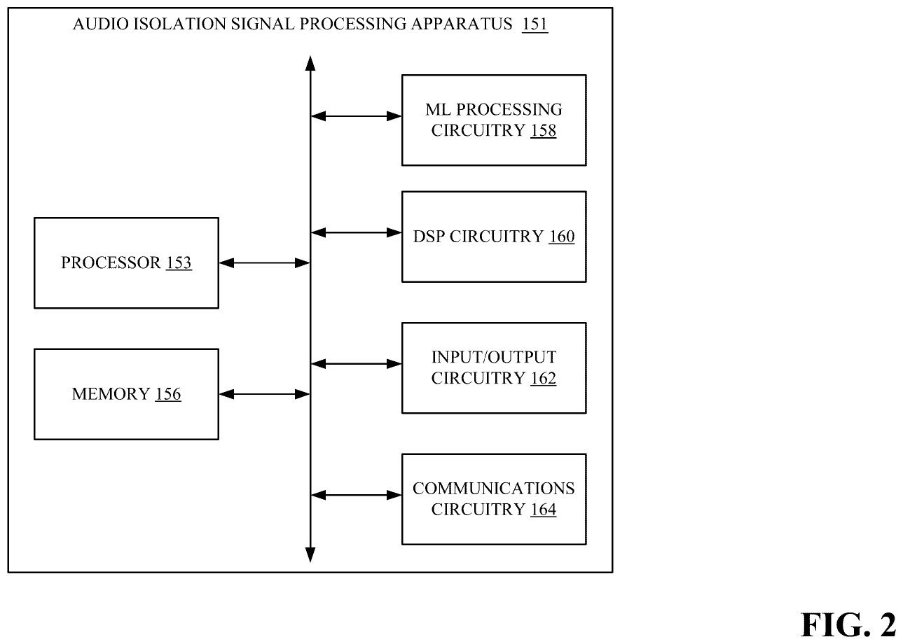

FIG. 2 illustrates an example audio isolation signal processing apparatus 151 configured in accordance with one or more embodiments of the present disclosure. The audio isolation signal processing apparatus 151 may be configured to perform one or more techniques described in FIG. 1 and/or one or more other techniques described herein. In one or more embodiments, the audio isolation signal processing apparatus 151 may be embedded in the audio isolation signal processing system 100.

In some cases, the audio isolation signal processing apparatus 151 may be a computing system communicatively coupled with, and configured to control, one or more circuit modules associated with audio processing. For example, the audio isolation signal processing apparatus 151 may be a computing system and/or a computing system communicatively coupled with one or more circuit modules related to audio processing. The audio isolation signal processing apparatus 151 may comprise or otherwise be in communication with a processor 153, a memory 156, ML processing circuitry 158, DSP processing circuitry 160, input/output circuitry 162, and/or communications circuitry 164. In some examples, the processor 153 (which may comprise multiple or co-processors or any other processing circuitry associated with the processor) may be in communication with the memory 156.

The memory 156 may comprise non-transitory memory circuitry and may comprise one or more volatile and/or non-volatile memories. In some examples, the memory 156 may be an electronic storage device (e.g., a computer readable storage medium) configured to store data that may be retrievable by the processor 153. In some examples, the data stored in the memory 156 may comprise radio frequency signal data, audio data, stereo audio signal data, mono audio signal data, or the like, for enabling the apparatus to carry out various functions or methods in accordance with embodiments of the present disclosure, described herein.

In some examples, the processor 153 may be embodied in a number of different ways. For example, the processor 153 may be embodied as one or more of various hardware processing means such as a central processing unit (CPU), a microprocessor, a coprocessor, a digital signal processor (DSP), an Advanced RISC Machine (ARM), a field programmable gate array (FPGA), a neural processing unit (NPU), a graphics processing unit (GPU), a system on chip (SoC), a cloud server processing element, a controller, or a processing element with or without an accompanying DSP. The processor 153 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 153 may comprise one or more processing cores configured to perform independently. A multi-core processor may enable multiprocessing within a single physical package. Additionally or alternatively, the processor 153 may comprise one or more processors configured in tandem via the bus to enable independent execution of instructions, pipelining, and/or multithreading.

In some examples, the processor 153 may be configured to execute instructions, such as computer program code or instructions, stored in the memory 156 or otherwise accessible to the processor 153. Alternatively or additionally, the processor 153 may be configured to execute hard-coded functionality. As such, whether configured by hardware or software instructions, or by a combination thereof, the processor 153 may represent a computing entity (e.g., physically embodied in circuitry) configured to perform operations according to an embodiment of the present disclosure described herein. For example, when the processor 153 is embodied as an CPU, DSP, ARM, FPGA, ASIC, or similar, the processor may be configured as hardware for conducting the operations of an embodiment of the disclosure described herein. Alternatively, when the processor 153 is embodied to execute software or computer program instructions, the instructions may specifically configure the processor 153 to perform the algorithms and/or operations described herein when the instructions are executed. However, in some cases, the processor 153 may be a processor of a device specifically configured to employ an embodiment of the present disclosure by further configuration of the processor using instructions for performing the algorithms and/or operations described herein. The processor 153 may further comprise a clock, an arithmetic logic unit (ALU) and logic gates configured to support operation of the processor 153, among other things.

In some examples, the audio isolation signal processing apparatus 151 may comprise the ML processing circuitry 158. The ML processing circuitry 158 may be any means embodied in either hardware or a combination of hardware and software that is configured to perform one or more functions disclosed herein related to machine learning. In some examples, the ML processing circuitry 158 may perform one or more functions associated with the one or more neural network models 110 and/or one or more other machine learning models disclosed herein related to machine learning. In some examples, the audio isolation signal processing apparatus 151 may comprise the DSP processing circuitry 160. The DSP processing circuitry 160 may be any means embodied in either hardware or a combination of hardware and software that is configured to perform one or more functions disclosed herein related to digital signal processing. In some examples, the DSP processing circuitry 160 may perform one or more operations associated with the pre-processing 108 and/or the post-processing 112. In some examples, the DSP processing circuitry 160 may perform one or more operations associated with applying computed masks and/or filters to the audio stream 104 to generate the isolated audio 106.

In some examples, the audio isolation signal processing apparatus 151 may comprise the input/output circuitry 162 that may, in turn, be in communication with processor 153 to provide output to the user and, in some examples, to receive an indication of a user input. The input/output circuitry 162 may comprise a user interface and may comprise a display. In some examples, the input/output circuitry 162 may also comprise a keyboard, a touch screen, touch areas, soft keys, buttons, knobs, or other input/output mechanisms.

In some examples, the audio isolation signal processing apparatus 151 may comprise the communications circuitry 164. The communications circuitry 164 may be any means embodied in either hardware or a combination of hardware and software that is configured to receive and/or transmit data from/to a network and/or any other device or module in communication with the audio isolation signal processing apparatus 151. In this regard, the communications circuitry 164 may comprise, for example, an antennae or one or more other communication devices for enabling communications with a wired or wireless communication network. For example, the communications circuitry 164 may comprise antennae, one or more network interface cards, buses, switches, routers, modems, and supporting hardware and/or software, or any other device suitable for enabling communications via a network. Additionally or alternatively, the communications circuitry 164 may comprise the circuitry for interacting with the antenna/antennae to cause transmission of signals via the antenna/antennae or to handle receipt of signals received via the antenna/antennae.

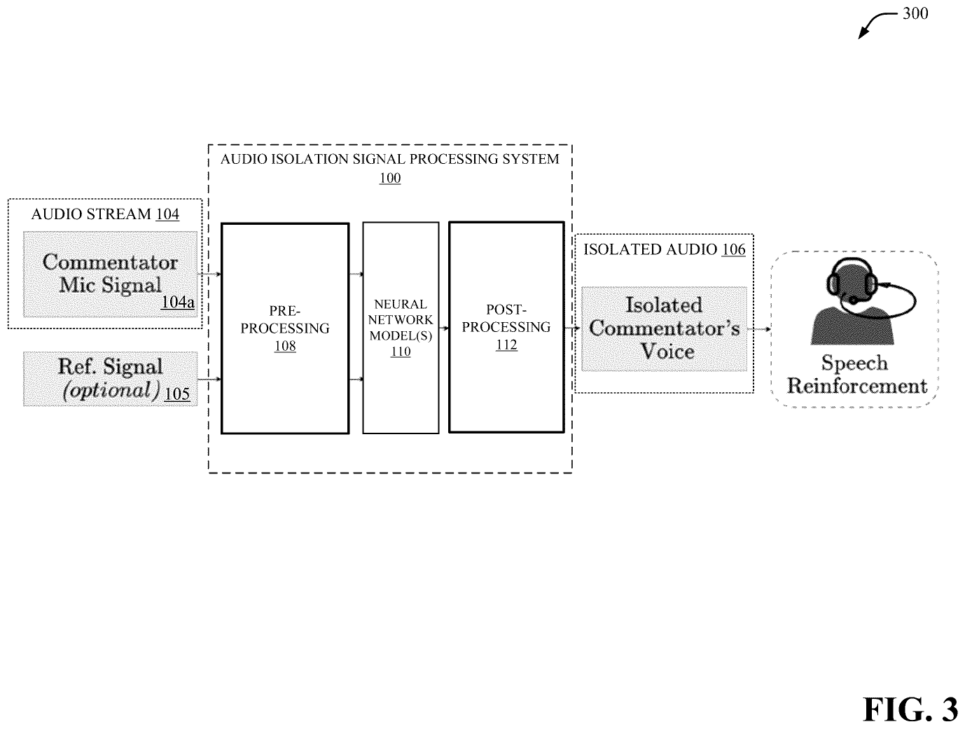

FIG. 3 illustrates an audio system 300 that is configured to provide audio enhancement and/or optimization of an immersive audio experience, according to embodiments of the present disclosure. In some examples, the audio system 300 is an intelligent DSP system. The audio system 300 includes the audio isolation signal processing system 100. The audio isolation signal processing system 100 is configured to perform at least audio isolation, denoising, speech removal, and/or other filtering of sound with respect to the audio stream 104 to provide the isolated audio 106. The audio stream 104 may include one or more commentator microphone signals 104a. Additionally, the audio stream 104 may be captured via one or more capture devices within the arena environment.

In some examples, the audio isolation signal processing system 100 may utilize the reference signal 105 to perform audio isolation, denoising, speech removal, and/or other filtering of sound with respect to the audio stream 104. It is to be appreciated that the reference signal 105 may be an optional input signal for the audio isolation signal processing system 100 such that the audio isolation signal processing system 100 may be executed with or without the reference signal 105 based on the particular implementation of the audio isolation signal processing system 100. For example, the reference signal 105 may be utilized to further improve noise isolation and/or noise cancellation for the commentator microphone signal 104a.

In some examples, the audio isolation signal processing system 100 generates an audio feature set (e.g., the audio feature set 107) for the audio stream 104 captured in the arena environment. In some examples, the audio feature set (e.g., the audio feature set 107) for the audio stream 104 may include one or more model input audio features for the commentator microphone signal 104a and/or the reference signal 105. Additionally, the audio feature set (e.g., the audio feature set 107) for the audio stream 104 may represent physical features and/or perceptual features related to the commentator microphone signal 104a and/or the reference signal 105. For instance, the one or more model input audio features may comprise: one or more: audio spectrum features, magnitude features, phase features, pitch features, harmonic features, MFCC features, performance features, performance sequencer features, tempo features, time signature features, and/or other types of features associated with the commentator microphone signal 104a and/or the reference signal 105.

In some examples, the audio isolation signal processing system 100 applies the pre-processing 108 to the audio stream 104. For instance, the audio isolation signal processing system 100 may apply respective pre-processing 108 to the commentator microphone signal 104a and/or the reference signal 105.

In some examples, the audio feature set (e.g., the audio feature set 107) for the audio stream 104 is input to the one or more neural network models 110 to generate an audio isolation mask (e.g., the audio isolation mask 109). For example, the one or more neural network models 110 may determine a denoiser mask, a speech removal mask, and/or a signal of interest mask for the commentator microphone signal 104a. Additionally or alternatively, the one or more neural network models 110 may determine a denoiser mask for the reference signal 105.

The audio isolation signal processing system 100 applies the at least one audio isolation mask 109 to the audio stream 104 to generate the isolated audio 106. In some examples, the isolated audio 106 includes an isolated commentator's voice for utilization via speech reinforcement.

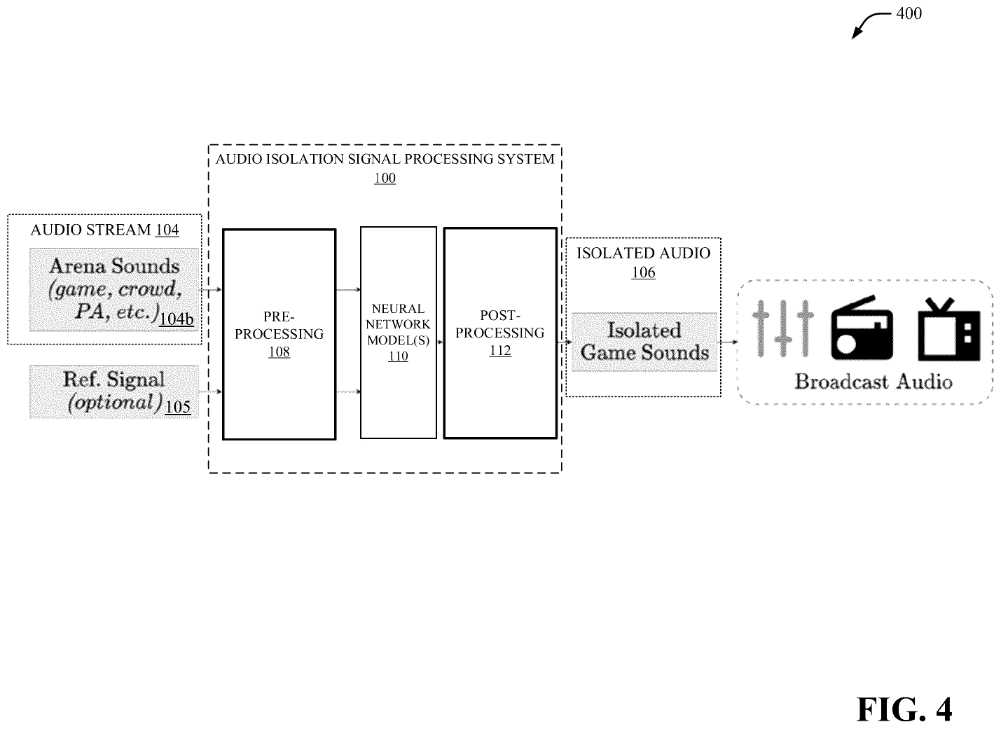

FIG. 4 illustrates an audio system 400 that is configured to provide audio enhancement and/or optimization of an immersive audio experience, according to embodiments of the present disclosure. In some examples, the audio system 400 is an intelligent DSP system. The audio system 400 includes the audio isolation signal processing system 100. The audio isolation signal processing system 100 is configured to perform at least audio isolation, denoising, speech removal, and/or other filtering of sound with respect to the audio stream 104 to provide the isolated audio 106. The audio stream 104 may include one or more arena sound microphone signals 104b. Additionally, the audio stream 104 may be captured via one or more capture devices within the arena environment.

In some examples, the audio isolation signal processing system 100 may utilize the reference signal 105 to perform audio isolation, denoising, speech removal, and/or other filtering of sound with respect to the audio stream 104. It is to be appreciated that the reference signal 105 may be an optional input signal for the audio isolation signal processing system 100 such that the audio isolation signal processing system 100 may be executed with or without the reference signal 105 based on the particular implementation of the audio isolation signal processing system 100. For example, the reference signal 105 may be utilized to further improve noise isolation and/or noise cancellation for the one or more arena sound microphone signals 104b.

In some examples, the audio isolation signal processing system 100 generates an audio feature set (e.g., the audio feature set 107) for the audio stream 104 captured in the arena environment. In some examples, the audio feature set (e.g., the audio feature set 107) for the audio stream 104 may include one or more model input audio features for the one or more arena sound microphone signals 104b and/or the reference signal 105. Additionally, the audio feature set (e.g., the audio feature set 107) for the audio stream 104 may represent physical features and/or perceptual features related to the one or more arena sound microphone signals 104b and/or the reference signal 105. For instance, the one or more model input audio features may comprise: one or more: audio spectrum features, magnitude features, phase features, pitch features, harmonic features, MFCC features, performance features, performance sequencer features, tempo features, time signature features, and/or other types of features associated with the one or more arena sound microphone signals 104b and/or the reference signal 105.

In some examples, the audio isolation signal processing system 100 applies the pre-processing 108 to the audio stream 104. For instance, the audio isolation signal processing system 100 may apply respective pre-processing 108 to the one or more arena sound microphone signals 104b and/or the reference signal 105.

In some examples, the audio feature set (e.g., the audio feature set 107) for the audio stream 104 is input to the one or more neural network models 110 to generate an audio isolation mask (e.g., the audio isolation mask 109). For example, the one or more neural network models 110 may determine a denoiser mask, a speech removal mask, and/or a signal of interest mask for the one or more arena sound microphone signals 104b. Additionally or alternatively, the one or more neural network models 110 may determine a denoiser mask for the reference signal 105.

The audio isolation signal processing system 100 applies the at least one audio isolation mask 109 to the audio stream 104 to generate the isolated audio 106. In some examples, the isolated audio 106 includes isolated game sounds (e.g., a squeak of shoes worn by the athlete, bouncing of a basketball on a basketball court, etc.) for utilization via broadcast audio.

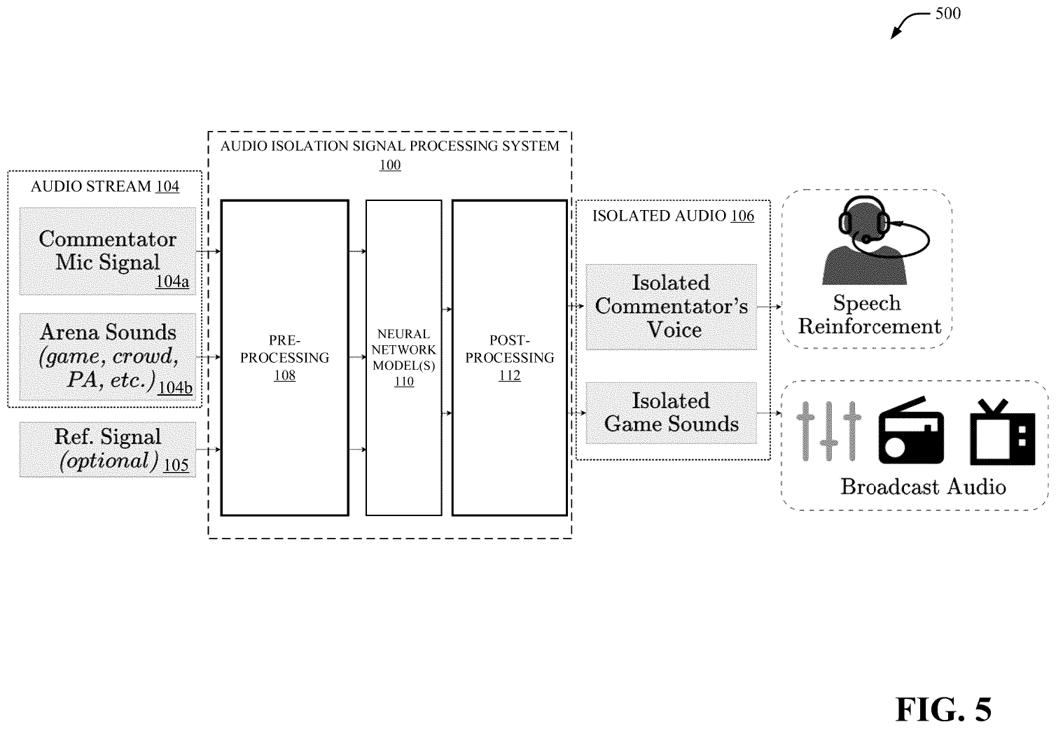

FIG. 5 illustrates an audio system 500 that is configured to provide audio enhancement and/or optimization of an immersive audio experience, according to embodiments of the present disclosure. In some examples, the audio system 500 is an intelligent DSP system. The audio system 500 includes the audio isolation signal processing system 100. The audio isolation signal processing system 100 is configured to perform at least audio isolation, denoising, speech removal, and/or other filtering of sound with respect to the audio stream 104 to provide the isolated audio 106. The audio stream 104 may include one or more commentator microphone signals 104a and one or more arena sound microphone signals 104b. Additionally, the audio stream 104 may be captured via one or more capture devices within the arena environment.

In some examples, the audio isolation signal processing system 100 may utilize the reference signal 105 to perform audio isolation, denoising, speech removal, and/or other filtering of sound with respect to the audio stream 104. It is to be appreciated that the reference signal 105 may be an optional input signal for the audio isolation signal processing system 100 such that the audio isolation signal processing system 100 may be executed with or without the reference signal 105 based on the particular implementation of the audio isolation signal processing system 100. For example, the reference signal 105 may be utilized to further improve noise isolation and/or noise cancellation for the commentator microphone signal 104a and/or the one or more arena sound microphone signals 104b.

In some examples, the audio isolation signal processing system 100 generates an audio feature set (e.g., the audio feature set 107) for the audio stream 104 captured in the arena environment. In some examples, the audio feature set (e.g., the audio feature set 107) for the audio stream 104 may include one or more model input audio features for the commentator microphone signal 104a, the one or more arena sound microphone signals 104b, and/or the reference signal 105. Additionally, the audio feature set (e.g., the audio feature set 107) for the audio stream 104 may represent physical features and/or perceptual features related to the commentator microphone signal 104a, the one or more arena sound microphone signals 104b, and/or the reference signal 105. For instance, the one or more model input audio features may comprise: one or more: audio spectrum features, magnitude features, phase features, pitch features, harmonic features, MFCC features, performance features, performance sequencer features, tempo features, time signature features, and/or other types of features associated with the commentator microphone signal 104a, the one or more arena sound microphone signals 104b, and/or the reference signal 105.

In some examples, the audio isolation signal processing system 100 applies the pre-processing 108 to the audio stream 104. For instance, the audio isolation signal processing system 100 may apply respective pre-processing 108 to the commentator microphone signal 104a, the one or more arena sound microphone signals 104b, and/or the reference signal 105.

In some examples, the audio feature set (e.g., the audio feature set 107) for the audio stream 104 is input to the one or more neural network models 110, and the one or more neural network models 110 generate an audio isolation mask (e.g., the audio isolation mask 109). For example, the one or more neural network models 110 may determine a denoiser mask, a speech removal mask, and/or a signal of interest mask for the one or more arena sound microphone signals 104b. Additionally or alternatively, the one or more neural network models 110 may determine a denoiser mask for the commentator microphone signal 104a and/or reference signal 105.

The audio isolation signal processing system 100 applies the at least one audio isolation mask 109 to the audio stream 104, and the result is an isolated audio 106. In some examples, the isolated audio 106 includes an isolated commentator's voice for utilization via speech reinforcement and isolated game sounds (e.g., a squeak of shoes worn by the athlete, bouncing of a basketball on a basketball court, etc.) for utilization via broadcast audio.

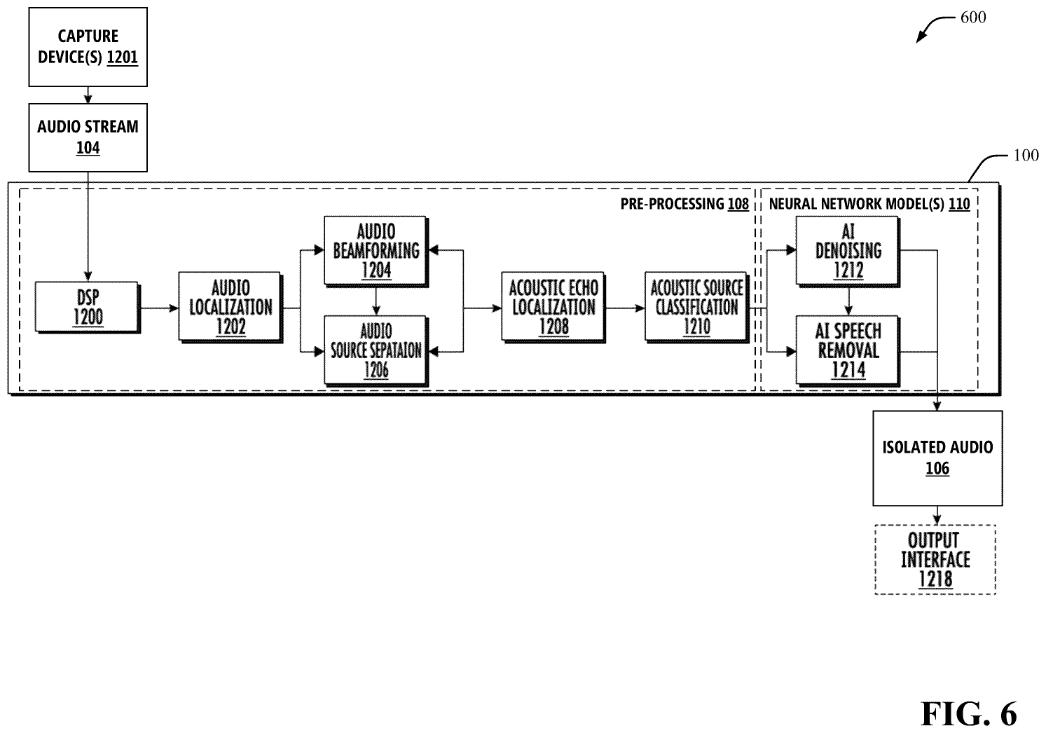

FIG. 6 illustrates an arena audio signal processing subsystem 600 that is configured to provide audio enhancement and/or optimization of an immersive audio experience, according to embodiments of the present disclosure. The arena audio signal processing subsystem 600 may be a subsystem and/or an example embodiment of the audio isolation signal processing system 100. In some examples, the arena audio signal processing subsystem 600 may include the audio isolation signal processing system 100. Additionally, the audio isolation signal processing system 100 includes at least the pre-processing 108 and the one or more neural network models 110.

The depicted audio isolation signal processing system 100 is configured to process the audio stream 104 captured by one or more capture devices 1201 located within an arena environment (not shown). The depicted audio isolation signal processing system 100 comprises various audio processing modules that are configured to receive audio signal streams from various capture devices positioned in and around the arena environment. For example, the audio isolation signal processing system 100 may be configured to analyze the captured audio signal streams and determine the relevance of the audio signal to the immersive audio experience for a remote spectator. Determining the relevance of an audio signal to the immersive audio experience may include identifying the source of the audio signal stream, identifying the content of the audio signal stream, and/or classifying the type of the audio signal stream.

As depicted in FIG. 6, the audio isolation signal processing system 100 includes a DSP module 1200 that is configured to use sound wave processing techniques to enhance or manipulate the audio stream 104. The DSP module 1200 may be used to perform operations such as automatic gain control, audio encoding/decoding, static and other simple noise removal, resampling, and the like.

The depicted audio isolation signal processing system 100 further includes an audio localization module 1202. In some examples, an audio localization module 1202 may be configured to map received audio waves and/or an audio source to a physical location in an arena environment. By assigning audio sources to a known physical location, the audio isolation signal processing system 100 may be configured to remove audio streams emanating from unwanted locations. Alternatively, the audio isolation signal processing system 100 may be configured to isolate and enhance the audio stream 104 emanating from desirable locations.

The depicted audio isolation signal processing system 100 is further configured to comprise an audio beamforming module 1204 configured to determine or refine beamformed lobes. The audio beamforming module 1204 may employ one or more beamforming techniques such as delay and sum, or may employ a deep neural network (DNN), other specifically trained machine learning (ML) models, or other artificial intelligence-based beamforming techniques.

The audio isolation signal processing system 100 is further configured to comprise an audio source separation module 1206. The audio source separation module 1206 as discussed herein is configured to isolate, route, or filter discrete audio sources from the audio stream 104. The audio source separation module 1206 may employ its own sophisticated DNN, ML, or artificial techniques to aid in the separation of audio sources. Additionally, the audio source separation module 1206 may be configured to route certain audio sources to dedicated audio channels for specific use cases. Further, the audio source separation module 1206 discussed herein may rely on audio beamforming from the audio beamforming module 1204 discussed above, while in other examples source separation may be performed without the aid of the audio beamforming module 1204. In some examples, audio source separation module 1206 may be a DSP-based source remover. In some examples, the audio source separation module 1206 may utilize a frequency domain filter to determine an audio source based on a ratio of a power of the signal of interest to a power of a signal to be removed. In other words, the audio source separation module 1206 may determine an audio source based on a ratio of a power of the signal of interest to noise to be removed.

The audio isolation signal processing system 100 as depicted in FIG. 6 further includes an acoustic echo cancelation module 1208 configured to reduce or null echo introduced into the audio stream 104 via the positioning of the sound wave capture devices proximate the arena environment. Additionally or alternatively, the audio isolation signal processing system 100 includes an acoustic source classification module 1210 that is configured to identify and label audio sources or classes. Acoustic source classification module 1210 as discussed herein may rely on classification techniques such as those that determine audio source from fixed microphone locations (e.g., audio streams from a coach mounted lavalier microphone may be reliably tagged as coach-sourced) or on more other techniques such as those that might employ complex ML clustering algorithms to distinguish between on-court sounds and off-court sounds. In various examples, the acoustic source classification module 1210 may be configured to classify the following audio sounds: crowd noise, player speech, floor sounds, ambient sound, PA noise, whistles, a squeak of shoes worn by the athlete, bouncing of a basketball on a basketball court, the “swish” of a basketball passing through a net, and the like.

In some examples, the acoustic source classification module 1210 may utilize machine learning or other artificial intelligence algorithms to identify specific acoustic sources and selectively include or exclude sources from the immersive audio experience. For example, the acoustic source classification module 1210 may be configured to identify a noise source and noise source components. A noise source refers to the origin or cause of noise, often undesirable, emanating from any region within an arena environment. A noise source may be a speaker (e.g., a public address speaker), arena speakers generating background music and/or advertisements, spectator conversations, wind, squeaking shoes, and/or other similar sounds. A noise source may provide a separate audio feed available to the immersive audio signal processing system through one or more additional audio channels. Identified sources may be selectively removed or enhanced and/or automatically removed or enhanced during operation.

The acoustic source classification module 1210 may be further configured to identify noise audio components. Noise audio components are any undesirable audio data received by a sound wave capture device within the arena environment. For example, noise audio components may include spectator conversations, exclamations from individual spectators, vendor exclamations, announcements from the PA system, background music, and other similar undesirable audio data.

The acoustic source classification module 1210 may utilize a noise source classification to identify an audio signal stream as a noise source and/or the noise audio components within the audio signal stream. A noise source classification refers to a set of features or parameters commonly associated with a noise source. For example, a noise source classification may include frequencies, amplitudes, reverberations, and other similar sound wave features, along with locations, distances, and other features common to one or more particular noise sources. In some examples, a noise source classification may be utilized to identify and isolate the noise source.

One or more beamformed lobes may be updated based on the noise source classification. Updating a beamformed lobe may include any action performed to enhance or suppress at least a portion of the received audio data. Updates to sound wave capture devices may include filtering or amplifying certain frequencies of audio data, and/or filtering or amplifying audio data based on location. Updates to beamformed lobes may be accomplished through DSP configuration and algorithms, enabling or disabling hardware or software filters, adjusting beamforming parameters to steer the location of beamformed lobes, and/or enabling or disabling portions of the digital sound wave capture device (e.g., condenser, transducer) to modify the field of capture of a sound wave capture device.

The depicted audio isolation signal processing system 100 may further include an AI denoising module 1212 that is configured to use DNN, ML, or other AI techniques to determine denoising masks that may be applied to an audio signal sample to remove, cancel, or mute undesired noise, speech, off-court sounds, PA announcements, arena music, and the like. An example AI denoising module 1212 is discussed in detail in connection with the audio processing systems disclosed in commonly owned U.S. patent application Ser. No. 17/679,904, titled “DEEP NEURAL NETWORK DENOISER MASK GENERATION SYSTEM FOR AUDIO PROCESSING,” and filed on Feb. 24, 2022, which is hereby incorporated by reference in its entirety.

The audio isolation signal processing system 100 may further include an AI speech removal module 1214 configured to utilize DNN, ML, or artificial intelligence techniques to recognize and remove undesired words and/or sounds from the audio signal streams. In some examples, the AI speech removal module 1214 may rely on AI denoising from the AI denoising module 1212 described herein to remove undesired noise before removing undesired speech. Alternatively, the AI speech removal may be performed without the aid of the AI denoising module 1212.

In various examples, one or more of the DSP module 1200, AI denoising module 1212, AI speech removal module 1214, acoustic echo cancelation module 1208, audio beamforming module 1204, acoustic source classification module 1210, audio source separation module 1206, or audio localization module 1202 may be omitted from the audio isolation signal processing system 100 and instead positioned within some other component of the audio isolation signal processing system 100. For example, one or more of the DSP module 1200, AI denoising module 1212, AI speech removal module 1214, acoustic echo cancelation module 1208, audio beamforming module 1204, acoustic source classification module 1210, audio source separation module 1206, or audio localization module 1202 may be configured for placement in one or more of the one or more capture devices 1201.

The audio isolation signal processing system 100 may be configured to process the audio stream 104 through one or more of the depicted DSP module 1200, AI denoising module 1212, AI speech removal module 1214, acoustic echo cancelation module 1208, audio beamforming module 1204, acoustic source classification module 1210, audio source separation module 1206, or audio localization module 1202 before outputting the isolated audio 106.

In the depicted example, the isolated audio 106 is transmitted to an output interface 1218. The output interface 1218 may be any electrical exchange boundary facilitating the transfer of the isolated audio 106 and other electronic data from the audio isolation signal processing system 100. In some examples, the output interface 1218 may include wiring, circuitry, cables, and/or another other communication medium. In some examples, the audio isolation signal processing system 100 may interface with a wireless antenna to output the isolated audio 106 as wireless data. In some examples, the output interface 1218 may be utilized to transmit output data to an output device.

In some examples, the isolated audio 106 may be transmitted to the output interface 1218 in discrete audio channels as informed by the processing of the audio signal streams. Transmitting the isolated audio 106 in discrete channels may allow a remote viewer or a broadcast audio producer (using a production sound mixer) to select targeted audio channels to enhance a particular camera view or video feed.

In some examples, the audio isolation signal processing system 100 may be configured to produce a digital environment encoding. A digital environment encoding refers to a set of configuration parameters, weights, or values that were identified or learned by the audio isolation signal processing system 100 or its constituent components (e.g., DSP module 1200, AI denoising module 1212, AI speech removal module 1214, acoustic echo cancelation module 1208, audio beamforming module 1204, acoustic source classification module 1210, audio source separation module 1206, audio localization module 1202, and/or the one or more neural network models 110) to identify and/or enhance preferred audio data and/or suppress, null, or filter undesirable audio data for a specific arena environment. In some examples, a digital environment encoding may include frequencies, amplitudes, sound wave patterns, and other similar sound wave features utilized by the various modules within the audio isolation signal processing system 100 to classify, identify, locate, isolate, and/or filter audio data specific to an arena environment.

In accordance with various examples, the isolated audio 106 produced by the audio isolation signal processing system 100 is configured to create an immersive audio experience for a remote spectator by virtually positioning the remote spectator within a particular region of an arena environment (e.g., a playing region, a spectator region, playing region adjacent area, etc.) while also optimizing the audio experience (e.g., amplifying or enhancing preferred sounds while filtering or removing undesirable sounds) for the particular region of the arena environment. In some examples, this remote spectator virtual position may be selected by a television producer or content generator while, in other examples, the remote spectator virtual position may be selected by remote spectators themselves by engaging virtual position option menus presented via a graphical user interface (e.g., an output interface). For example, a remote spectator may choose to begin watching a baseball game virtually by selecting a first immersive audio experience generated from the perspective of the spectator region of a baseball stadium environment but later switch, via option menus rendered via a graphical user interface, to a second immersive audio experience generated from the perspective of the dugout (e.g., a playing region adjacent area).

Additional details related to the audio isolation signal processing system 100 are discussed in detail in connection with the intelligent digital signal processor disclosed in commonly owned U.S. patent application Ser. No. 18/344,610, titled “MULTI-LOBE DIGITAL MICROPHONE ENABLED AUDIO CAPTURE AND SPATIALIZATION FOR GENERATING AN IMMERSIVE ARENA BASED AUDIO EXPERIENCE,” and filed on Jun. 29, 2023, which is hereby incorporated by reference in its entirety.

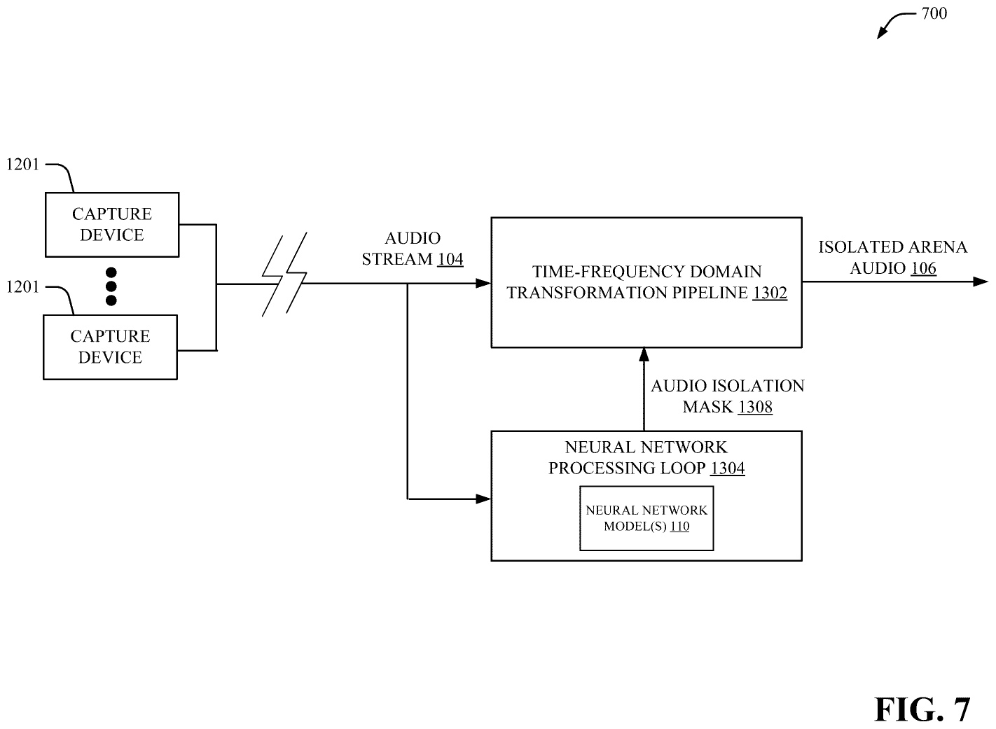

FIG. 7 illustrates an arena audio signal processing subsystem 700 that is configured to provide audio enhancement and/or optimization of an immersive audio experience, according to embodiments of the present disclosure. The arena audio signal processing subsystem 700 may be a subsystem and/or an example embodiment of the audio isolation signal processing system 100 and/or the arena audio signal processing subsystem 600. The arena audio signal processing subsystem 700 includes a time-frequency domain transformation pipeline 1302 and a neural network processing loop 1304. In some examples, the neural network processing loop 1304 corresponds to the AI denoising module 1212.

In some examples, the audio stream 104 generated by the one or more capture devices 1201 may be converted into one or more audio signal samples. The one or more audio signal samples associated with the audio stream 104 may be provided to the time-frequency domain transformation pipeline 1302 for a transformation period. The time-frequency domain transformation pipeline 1302 may form part of a digital signal processing process. Additionally, the one or more audio signal samples may be provided to the neural network processing loop 1304. The neural network processing loop 1304 may include the one or more neural network models 110 configured to generate at least one audio isolation mask 1308.

In some examples, the one or more audio signal samples are converted into a non-uniform-bandwidth frequency domain representation. Additionally, the non-uniform-bandwidth frequency domain representation of the one or more audio signal samples may be input to the one or more neural network models 110. In some examples, the non-uniform-bandwidth frequency domain representation includes a Bark scale format, an Equivalent Rectangular Bandwidth (ERB) format, a wavelet filter banks format, an MFCC format, or another type of format.

In a circumstance where at the at least one audio isolation mask 1308 is determined prior to expiration of the transformation period, the at least one audio isolation mask 1308 may be applied to a frequency domain version of the one or more audio signal samples associated with the time-frequency domain transformation pipeline 1302 to generate the isolated audio 106.

Additional details related to the time-frequency domain transformation pipeline 1302 and/or the neural network processing loop 1304 are discussed in detail in connection with the audio processing systems disclosed in commonly owned U.S. patent application Ser. No. 17/679,904, titled “DEEP NEURAL NETWORK DENOISER MASK GENERATION SYSTEM FOR AUDIO PROCESSING,” and filed on Feb. 24, 2022, which is hereby incorporated by reference in its entirety.

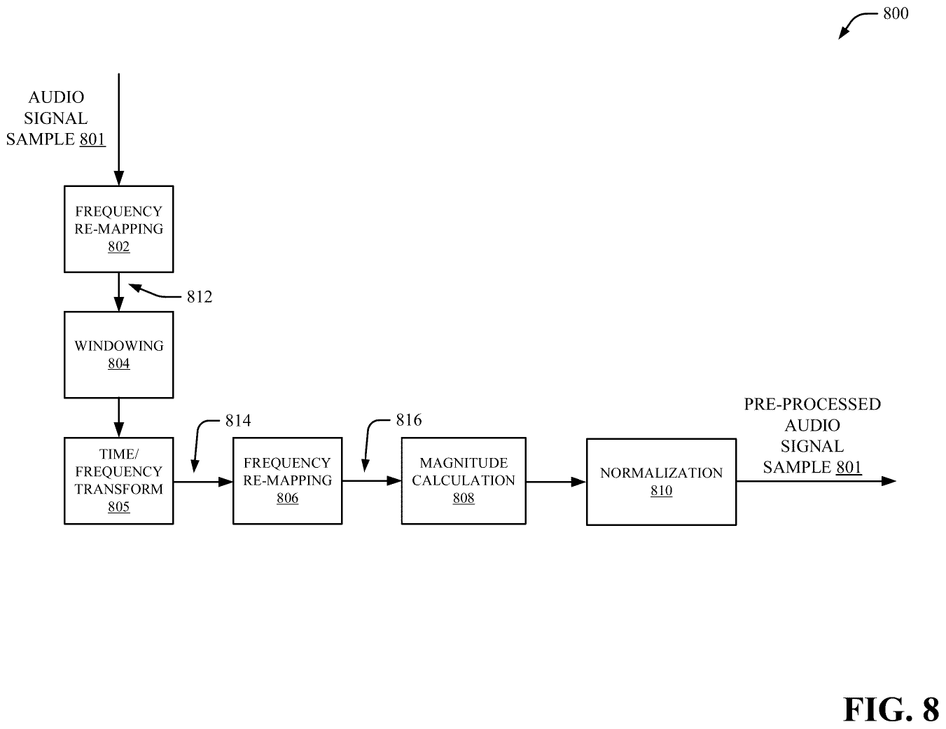

FIG. 8 illustrates a pre-processing subsystem 800 according to embodiments of the present disclosure. The pre-processing subsystem 800 may be a subsystem and/or an example embodiment of the pre-processing 108. The pre-processing subsystem 800 includes frequency re-mapping 802, windowing 804, the time/frequency transform 805, frequency re-mapping 806, a magnitude calculation 808, and/or normalization 810.

To reduce computation time, reduce input dimensionality, and/or format input data according to one or more input data rules for the one or more neural network models 110, an audio signal sample 801 may be provided to the frequency re-mapping 802. The audio signal sample may correspond to at least a portion of the audio stream 104. The frequency re-mapping 802 may be configured to modify (e.g., scale) frequency of one or more portions of the audio signal sample 801 to generate a modified audio signal sample 812. The modified audio signal sample 812 may be a modified version of the audio signal sample 801 where a frequency scale for the modified audio signal sample 812 is different than a frequency scale for the audio signal sample 801. For example, the audio signal sample 801 may be associated with a first frequency scale (e.g., a uniformly spaced frequency representation) and the modified audio signal sample 812 may be associated with a second frequency scale (e.g., a non-uniformly spaced frequency representation). A combination of the frequency re-mapping 802, the windowing 804 and the time/frequency transform 805 may correspond to a warped discrete Fourier transform.

The time/frequency transform 805 may be configured to transform the audio signal sample 801 (e.g., a time domain signal sample version of the audio signal sample 801) into a frequency domain audio signal sample version of the audio signal sample 801. In certain examples, the time/frequency transform 805 may include a Fourier transform (e.g., a fast Fourier transform, a short-time Fourier transform, etc.) that transforms the audio signal sample 801 into the frequency domain audio signal sample. In certain examples, the time/frequency transform 805 may include a discrete cosine transform that transforms the audio signal sample 801 into the frequency domain audio signal sample In certain examples, the time/frequency transform 805 may include a cochleargram transform that transforms the audio signal sample 801 into the frequency domain audio signal sample. In certain examples, the time/frequency transform 805 may include a wavelet transform that transforms the audio signal sample 801 into the frequency domain audio signal sample. In certain examples, the time/frequency transform 805 may include one or more filter banks that facilitates transforming the audio signal sample 801 into the frequency domain audio signal sample.

The frequency re-mapping 802 may employ one or more digital filters associated with one or more frequency warping operations (e.g., a bilinear transform, an all-pass transformation, etc.) to provide the modified audio signal sample 812. In one or more examples, the windowing 804 may perform one or more windowing operations with respect to the modified audio signal sample 812 to segment the modified audio signal sample 812 into a set of segmented portions for processing by the time/frequency transform 805. The time/frequency transform 805 may be configured to transform the modified audio signal sample 812 (e.g., a time domain signal sample version of the modified audio signal sample 812) into a frequency domain audio signal sample 814 (e.g., a frequency domain audio signal sample version of the modified audio signal sample 812).

The frequency re-mapping 806 facilitates reduced latency by reducing computation time and/or by lowering input dimensionality to the one or more neural network models 111. For example, the frequency re-mapping 806 may be configured for remapping and/or reducing frequency dimensionality for the one or more neural network models 111. Furthermore, the frequency re-mapping 802 facilitates improved quality of the at least one audio isolation mask 109 by allocating lower frequencies to the one or more neural network models 111 and/or by reducing a number of computing resources allocated to higher frequencies (e.g., similar to how a human car operates). For example, the frequency re-mapping 802 may be configured for improved accuracy of the at least one audio isolation mask 109.

In one or more examples, the frequency domain audio signal sample 814 may be provided to the frequency re-mapping 806. The frequency re-mapping 806 may be configured to modify (e.g., scale) frequency of one or more portions of the frequency domain audio signal sample 814 to generate a modified frequency domain audio signal sample 816 (e.g., Bark scale). The modified frequency domain audio signal sample 816 may be a modified version of the frequency domain audio signal sample 814 where a frequency scale for the modified frequency domain audio signal sample 816 is different than a frequency scale for the frequency domain audio signal sample 814. For example, the frequency domain audio signal sample 814 may be associated with the second frequency scale (e.g., Bark scale) and the modified frequency domain audio signal sample 816 may be associated with the frequency scale (e.g., frequency domain).

In some examples, the frequency re-mapping 806 may employ one or more digital filters and/or one or more transformation filters associated with one or more frequency warping operations (e.g., a bilinear transform, a Bark transformation, etc.) to provide the modified frequency domain audio signal sample 816. In certain examples, the magnitude calculation 808 may determine magnitude of one or more portions of the modified frequency domain audio signal sample 816. The magnitude calculation 808 may facilitate generation of a magnitude spectrogram associated with the modified frequency domain audio signal sample 816. Based on the magnitude of one or more portions of the modified frequency domain audio signal sample 816 (e.g., based on the magnitude spectrogram associated with the modified frequency domain audio signal sample 816), the normalization 810 may normalize an energy mean and/or a variance of the modified frequency domain audio signal sample 816. In some examples, the normalized version of the modified frequency domain audio signal sample 816 may correspond to a pre-processed audio signal sample 801 that is configured for improved feature extraction and/or input into the one or more neural network models 110.

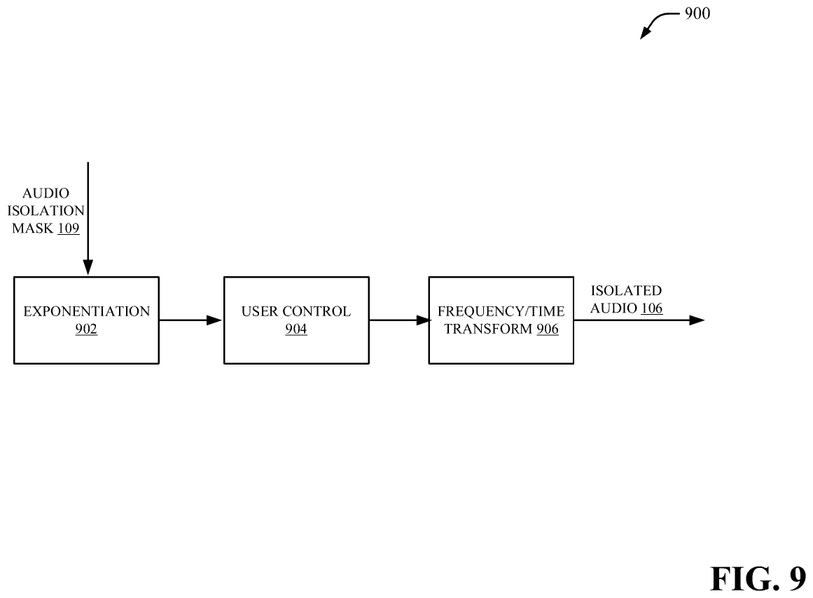

FIG. 9 illustrates a post-processing subsystem 900 according to embodiments of the present disclosure. The post-processing subsystem 900 may be a subsystem and/or an example embodiment of the post-processing 112. The post-processing subsystem 900 includes exponentiation 902, user control 904, and/or a frequency/time transform 906.

The exponentiation 902 may be configured to apply the audio isolation mask 109 to one or more portions of the audio stream 104. For example, the exponentiation 902 may be configured to perform a multiply function, such as, for example, a Hadamard product, to apply the audio isolation mask 109 to one or more portions of the audio stream 104. In some examples, the exponentiation 902 may be configured to apply the audio isolation mask 109 to a frequency domain version of the audio stream 104.

The frequency/time transform 906 may be configured to transform the audio isolated frequency domain version of the audio stream 104 into the isolated audio 106. In some examples, the frequency/time transform 906 may include an inverse Fourier transform (e.g., an inverse fast Fourier transform, an inverse short-time Fourier transform, an inverse discrete cosine transform, an inverse cochleargram transform, etc.) that transforms the audio isolated frequency domain version of the audio stream 104 into the isolated audio 106. In some examples, the frequency/time transform 906 may additionally include an inverse Bark conversion process to transforms the audio isolated frequency domain version of the audio stream 104 into the isolated audio 106. In some examples, the audio isolated frequency domain version of the audio stream 104 may be modified based on the user control 904 prior to being transformed via the frequency/time transform 906. For example, the user control 904 may utilize the one or more user audio isolation control parameters 120 to modify audio isolated frequency domain version of the audio stream 104.

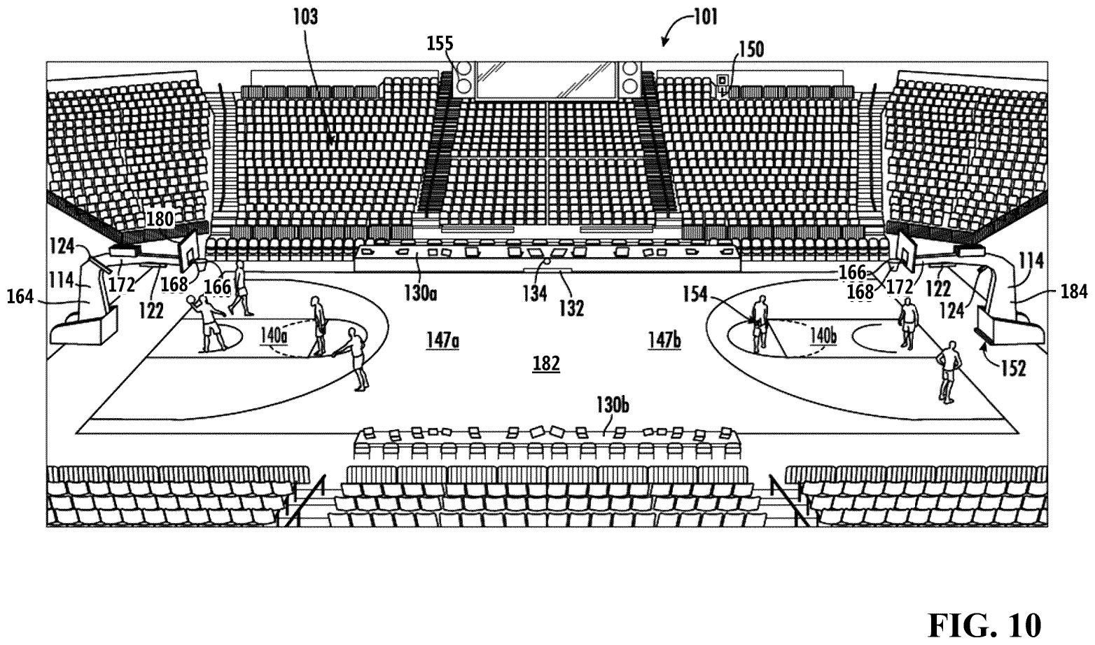

FIG. 10 illustrates an example arena environment 101 that is configured to include the audio isolation signal processing system 100 structured in accordance with various embodiments of the present disclosure. The depicted arena environment 101 is a basketball arena environment. However, s as discussed herein may be configured for operation within a variety of arena environments including football stadium environments, hockey stadium environments, soccer stadium environments, baseball stadium environments, concert hall or stadium environments, theatrical environments, and the like, without departing from the scope of the present disclosure. It will be appreciated that, while embodiments herein are described with respect to an arena environment for illustrative purposes, innovations described herein are applicable to other environments without departing from the scope of the present disclosure.

The example arena environment 101 depicted in FIG. 10 includes a rectangular playing region 182 having two ends and two sides, player bench areas 156a, 156b adjacent to the playing region 182, a spectator region 103, and a noise source region 155. The depicted noise source region 155 includes a jumbotron video board with speakers on lateral sides for playing music and PA remarks to spectators seated in the spectator region 103.

An arena environment may further include a playing region adjacent area (e.g., player bench area 156a, 156b). A playing region adjacent area refers to the physical area of the arena environment in which performers are positioned when they are not in the playing region. For example, the playing region adjacent area may include player bench areas (e.g., player bench area 156a, 156b) in a basketball arena environment, the dugout area in a baseball stadium environment, the backstage area in a concert or theater arena environment, and other similar areas adjacent to a playing region.

At each end of the playing region 182 is a basketball hoop support assembly 184. Each basketball hoop support assembly 184 comprises a rim 166 with an attached net 168 and connected to a backboard 180. Each basketball hoop support assembly 184 further comprises a horizontal hoop support beam 172 and a vertical hoop support beam 114 physically coupled by a support beam connector and configured to hold the backboard 180, rim 166, and net 168 in an elevated position. Each basketball hoop support assembly 184 is configured to support a number of capture devices.

In FIG. 10, a support base linear array sound wave capture device 152 is depicted positioned near the base of the basketball hoop support assembly 184. In the depicted example, the support base linear array sound wave capture device 152 is directed generally toward the surface of the playing region 182. Positioning a support base linear array sound wave capture device 152 near the base of the basketball hoop support assembly 184 and directed toward the playing region 182 allows overlapping coverage of the areas of the court of highest interest, such as the key areas (140a, 140b) and surrounding areas.

As disclosed herein, an array sound wave capture device such as the linear array sound wave capture device 152 refers to a sound wave capture device comprising a plurality of transducers configured to utilize signal processing techniques to uniformly capture and process sound wave data. An array sound wave capture device may use beamforming techniques to produce one or more steerable beamformed lobes. Example array sound wave capture devices include linear array sound wave capture devices, planar array sound wave capture devices, circular array sound wave capture devices, 2D array sound wave capture devices, 3D surface array sound wave capture devices, suspended 3D array sound wave capture devices, and the like. Array sound wave capture devices may further include 1.5D array sound wave capture devices. A 1.5D array sound wave capture device is an array sound wave capture device configured to provide a one-dimensional form factor that, in some examples, has added directivity, for most, if not all, frequencies, in dimensions that, conventionally, have equal sensitivity in all directions.

In some examples, an array sound wave capture device includes a plurality of transducers arranged such that the length of the array of transducers exceeds the width. In some examples, a linear array arrangement of transducers may allow a linear array sound wave capture device to be configured to use highly selective end fire beamformed lobes to capture sound emanating from a direction parallel to the linear array and broadside beamformed lobes to capture sound emanating from a direction perpendicular to the linear array. As referenced herein, example linear array sound wave capture devices include ground linear array sound wave capture devices, hanging linear array sound wave capture devices, angled linear array sound wave capture devices, support base linear array sound wave capture devices, spectator linear array sound wave capture devices, and the like.

The depicted support base linear array sound wave capture device 152 may be, for example, a four-foot array sound wave capture device that is configured to produce up to 8 beamformed steerable lobes. Although depicted as a linear array sound wave capture device, the support base linear array sound wave capture device 152 may be any multi-lobe digital sound wave capture device capable of capturing playing region audio content.

As referenced herein, a multi-lobe digital sound wave capture device refers to any sound wave capture device configured to filter and/or enhance received sound waves to achieve spatial selectivity in the form of discrete beamformed lobes. In some examples, a multi-lobe digital sound wave capture device may comprise a steerable digital sound wave capture device. In some examples, a multi-lobe digital sound wave capture device may comprise a switchable sound wave capture device.

A steerable digital sound wave capture device refers to any multi-lobe digital sound wave capture device that is configured to move or reposition one or more beamformed lobes from a first audio capture area to a second audio capture area. Such adjustment may be performed via beamforming techniques, such as delay and sum. In some examples, the width, distance, and number of beamformed lobes generated by a steerable digital sound wave capture device may be adjusted through beamforming techniques. Example steerable digital sound wave capture devices include various array sound wave capture devices. In some examples, a steerable digital sound wave capture device may be configured to transmit and receive wireless communication such that one or more beamformed lobes may be updated remotely.

As referenced herein, an audio capture area refers to the physical area from which a particular capture device may receive audio data. For example, in a directed capture device, such as a shotgun microphone, the audio capture may include a narrow but long audio capture area, such that audio data may be captured from physical locations in a very narrow or directed set of locations. In another example, a circular array sound wave capture device may simultaneously capture audio data in a wide set of physical locations. Some devices, such as multi-lobe digital sound wave capture devices may be continually updated to change the audio capture area of the device. In some instances, a multi-lobe sound wave capture device may be configured to capture audio data from a narrow audio capture area, while in other instances, a multi-lobe sound wave capture device may be configured to capture audio data from a wide audio capture area. In general, a narrow audio capture area may receive audio data from further physical locations due to reductions in noise from other audio sources.

To capture additional audio content on or near the playing region 182, some or all of the participants (e.g., players, coaches, referees, etc.) may be equipped with a bodypack sound wave capture device 154. The depicted bodypack sound wave capture device 154 is a player microphone, however, the bodypack sound wave capture device 154 may be any sound wave capture device that may be worn by a player or other participant while still providing for participation. Utilization of a bodypack sound wave capture device 154 allows capture and transmission of player, coach, and referee conversations, as well as other on-court and in-game audio content that adds to an immersive audio experience. Such bodypack sound wave capture devices 154 also allow for the capture of playing region adjacent area audio data, such as player bench area 156a, 156b audio coverage.

The depicted arena environment 101 further includes a first scorer's table 130a and a second scorer's table 130b positioned on the surface of the playing region 182 and running parallel to each lateral side of the playing region 182. In the depicted example, a table top array sound wave capture device 134 has been hung from the first scorer's table 130a and directed toward the playing region 182. A ground linear array sound wave capture device 132 is disposed on the floor surface of the playing region 182 at the base of the first scorer's table 130a and directed upward from the surface of the playing region 182.

During a basketball game, the depicted playing region 182 is populated with participating players, referees, team coaches, cheerleaders, halftime show members, and others. These participants will create a variety of sounds, many of which are not effectively captured by directional microphone setups but which, if captured, would add considerable value to an immersive audio experience for a remote viewing spectator. For example, conversations between players, coaches, and referees; player exclamations; floor noises such as squeaking shoes and bouncing balls; whistles; and so on, collectively referred to as on-court sounds are inconsistently or infrequently captured but should play a central role in any immersive experience. Playing region adjacent area noises, such as conversations in the player bench area 156a, 156b, may be selectively included or excluded in an immersive audio experience.

The depicted arena environment 101 includes a spectator region 103. The spectator region refers to the portion of the arena environment designated for in-person spectators during game play or a performance. The spectator region includes seating and viewing areas for in-person spectators to watch the events occurring in the playing region. In some examples, the spectator region may be configured in an amphitheater configuration such that it fully or partially encircles the playing region. The spectator region may also be configured to encompass one or two lateral sides of the playing region. The depicted spectator region 103 of FIG. 10 provides seating and viewing areas for in-person spectators to watch the basketball game occurring in the playing region 182.

The depicted spectator region 103 may be the source of a number of sounds during a basketball game. Some of these sounds may be desirable for inclusion in a television broadcast while others are undesirable and should be excluded. For example, crowd cheers and boos may be considered as desirable sounds to be included in a television broadcast while other sounds, such as spectator conversations, exclamations from individual spectators, and announcements from the PA system, may be deemed undesirable.

In addition, FIG. 10 depicts a spectator linear array sound wave capture device 150. In the depicted example, the spectator linear array sound wave capture device 150 is mounted to the base of a camera positioned in the spectator region 103. Mounting a spectator linear array sound wave capture device 150 on or near a camera may allow an ambient perspective immersive audio experience to be created, such that the captured audio content corresponds with the movement and/or panning of the camera.

Although the depicted spectator linear array sound wave capture device 150 is mounted to the base of a camera positioned in the spectator region 103, a spectator linear array sound wave capture device 150 may be positioned on or near the body of the camera, or anywhere in or near the spectator region 103. The depicted spectator linear array sound wave capture device 150 is a four-foot array sound wave capture device, however, the spectator linear array sound wave capture device 150 may be any multi-lobe digital sound wave capture device configured to capture and transmit surrounding audio content. Utilizing a spectator linear array sound wave capture device 150 allows the capture of in-audience sounds adding to the immersive audio experience. Although only one spectator linear array sound wave capture device 150 is shown, multiple such devices may be used throughout the spectator region 103 as may be appropriate for adequate audio coverage.

Some wave capture devices may be strategically placed to capture and process audio signal streams originating from the spectator region 103. Depending on the desired user experience, this audio content may be mixed with other streams for transmission to a remote viewing display. Alternatively, the audio signal streams from the spectator region 103 may be isolated according to classified audio source (e.g., shouting vendors, etc.) and/or locality and may be selectively removed from audio streams that form a desired immersive audio experience.

For example, the audio isolation signal processing system 100 may be configured to provide a playing region 182 audio stream mixed with an audio stream of cheers and boos drawn from a crowd seated in the spectator region 103 to add to the immersive audio experience. While in another immersive audio experience, the audio isolation signal processing system 100 may be configured to provide a playing region 182 audio stream with audio signal streams originating from the spectator region 103 entirely removed, if, for example, there is a desire to emphasize player conversations, coaches and referee discussions, floor sounds, or other indistinct on-court sounds.

As further depicted in FIG. 10, the arena environment 101 includes a noise source region 155. A noise source region refers to the portion of the arena environment from which additional sound waves may emanate. In some examples, the noise source region may include sound waves from the PA announcer, audio advertisements and announcements, music, and other sounds emanating from the arena environment speakers.

The arena environment 101 may also include sound wave capture devices (not shown) that are directed toward the noise source region 155. By capturing noise source region 155 originating audio signal streams, such immersive audio signal processing systems are configured to isolate or cancel audio from the noise source region 155. Alternatively, audio streams originating from the noise source region 155 may be captured without dedicated sound wave capture devices by tapping an audio feed to the depicted jumbotron or speaker array to provide an auxiliary audio feed.

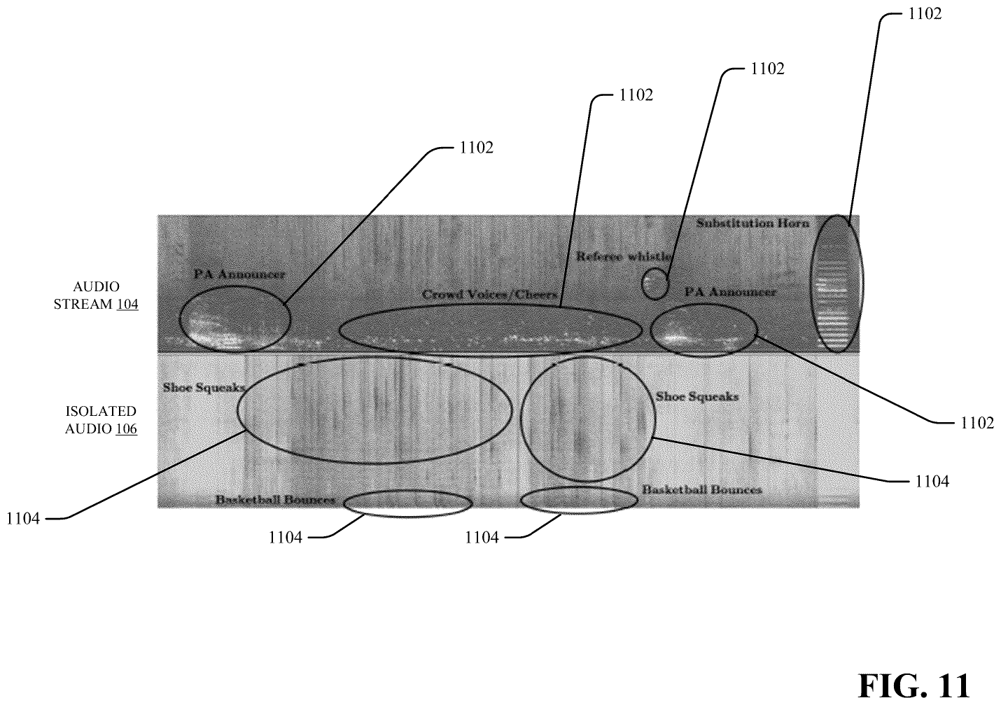

FIG. 11 illustrates an example audio stream and isolated arena audio in accordance with various embodiments of the present disclosure. For example, the audio stream 104 provided to the audio isolation signal processing system 100 may include various arena sounds 1102 such as PA announcer audio, crowd voices, crowd cheers, a referee whistle, a substitution horn, and/or the like. Additionally, the isolated audio 106 generated by the audio isolation signal processing system 100 may include various isolated game sounds 1104 such as shoe squeaks, basketball bounces, and/or the like.

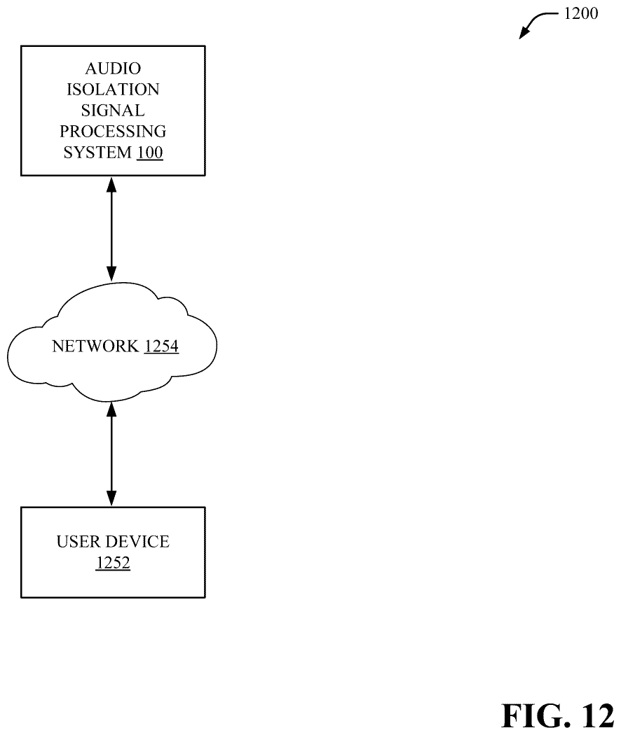

FIG. 12 illustrates an example system 1200 according to one or more embodiments of the present disclosure. The system 1200 includes a user device 1252 configured to interact with the audio isolation signal processing system 100 via a network 1254. For example, in one or more embodiments, the user device 1252 may be configured to send data to the audio isolation signal processing system 100 and/or receive data from the audio isolation signal processing system 100. In certain embodiments, the user device 1252 may be configured to send the one or more user audio isolation control parameters 120 to the audio isolation signal processing system 100 via the network 1254. In certain embodiments, the user device 1252 may be configured to receive dynamic isolated audio interface data (e.g., data associated with a dynamic audio isolation interface, etc.) from the audio isolation signal processing system 100.

In certain embodiments, the user device 1252 may be configured to render a dynamic isolated audio interface to visually indicate a degree of isolated arena audio provided by the at least one audio isolation mask 109. For example, in certain examples, the user device 1252 may be configured to render an isolated audio meter interface to visually indicate a degree of noise reduction, dereverberation, and/or other audio filtering provided by the at least one audio isolation mask 109. The user device 1252 may be a smartphone, a tablet computer, a laptop, a personal computer, an audio workstation device, a wearable device, an augmented reality device, a virtual reality device, or another type of user device that includes one or more displays.

The network 1254 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 1254 (e.g., network routers, etc.). For example, the network 1254 may include a cellular telephone, an 802.11, 802.16, 802.18, and/or WiMAX network. Further, the network 1254 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some examples, the protocol is a custom protocol of JSON objects sent via a WebSocket channel. In some examples, the protocol is JSON over RPC, JSON over REST/HTTP, the like, or combinations thereof. In some examples, the network 1254 is configured for exchanging data over short distances (e.g., less than 33 feet) using ultra high frequency (UHF) radio waves.

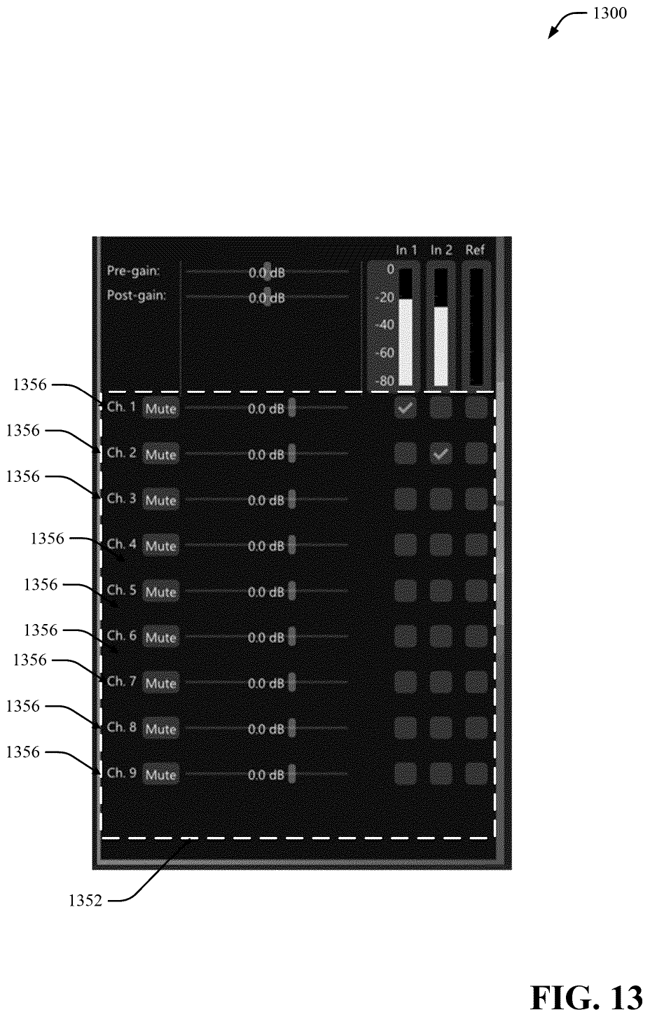

FIG. 13 illustrates an audio processing control user interface 1300 according to one or more embodiments of the present disclosure. The audio processing control user interface 1300 may be, for example, an electronic interface (e.g., a graphical user interface) of a client device (e.g., the user device 1252). For example, the audio processing control user interface 1300 may be a client device interface, a web user interface, a mobile application interface, or the like. In one or more examples, the audio processing control user interface 1300 includes a dynamic channel control interface 1352.

In some examples, the dynamic channel control interface 1352 includes one or more user engagement audio channel interfaces 1356. In some examples, one or more user engagement audio channel interfaces 1356 may respectively be a slide control interface configured to control and/or modify a value of the one or more user audio isolation control parameters 120 for a respective audio channel of the audio stream 104. In some examples, in response to a user engagement with respect to the one or more user engagement audio channel interfaces 1356, one or more control signals associated with the one or more user audio isolation control parameters 120 may be transmitted to the audio isolation signal processing system 100 via the network 1254.

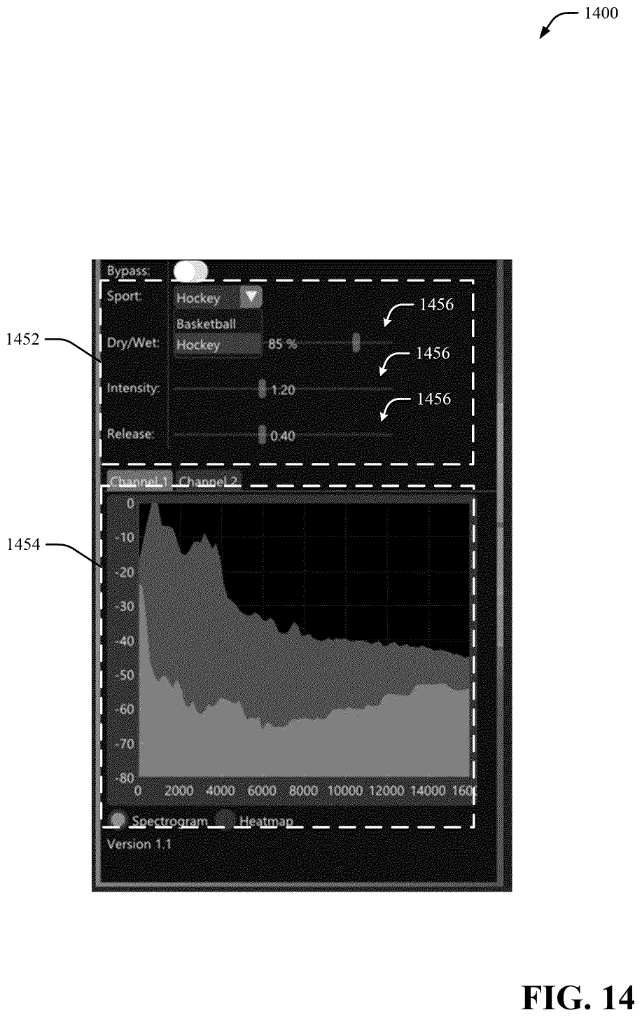

FIG. 14 illustrates an audio processing control user interface 1400 according to one or more embodiments of the present disclosure. The audio processing control user interface 1400 may be, for example, an electronic interface (e.g., a graphical user interface) of a client device (e.g., the user device 1252). For example, the audio processing control user interface 1400 may be a client device interface, a web user interface, a mobile application interface, or the like. In one or more examples, the audio processing control user interface 1400 includes a dynamic user audio isolation control interface 1452 to dynamically generate and/or modify the one or more user audio isolation control parameters 120. In one or more examples, the audio processing control user interface 1500 additionally or alternatively includes a spectrogram visualization 1454 to dynamically render visual data associated with the isolated audio 106 via a spectrogram.

In some examples, the dynamic user audio isolation control interface 1452 includes one or more user engagement interfaces 1456. In some examples, one or more user engagement interfaces 1456 may respectively be a slide control interface configured to control and/or modify a value of the one or more user audio isolation control parameters 120 for the audio stream 104. In some examples, may enable user control of intensity audio characteristics, release audio characteristics, reverberation audio characteristics, and/or one or more other audio characteristics for the isolated audio 106. In some examples, in response to a user engagement with respect to the one or more user engagement interfaces 1456, one or more control signals associated with the one or more user audio isolation control parameters 120 may be transmitted to the audio isolation signal processing system 100 via the network 1254.

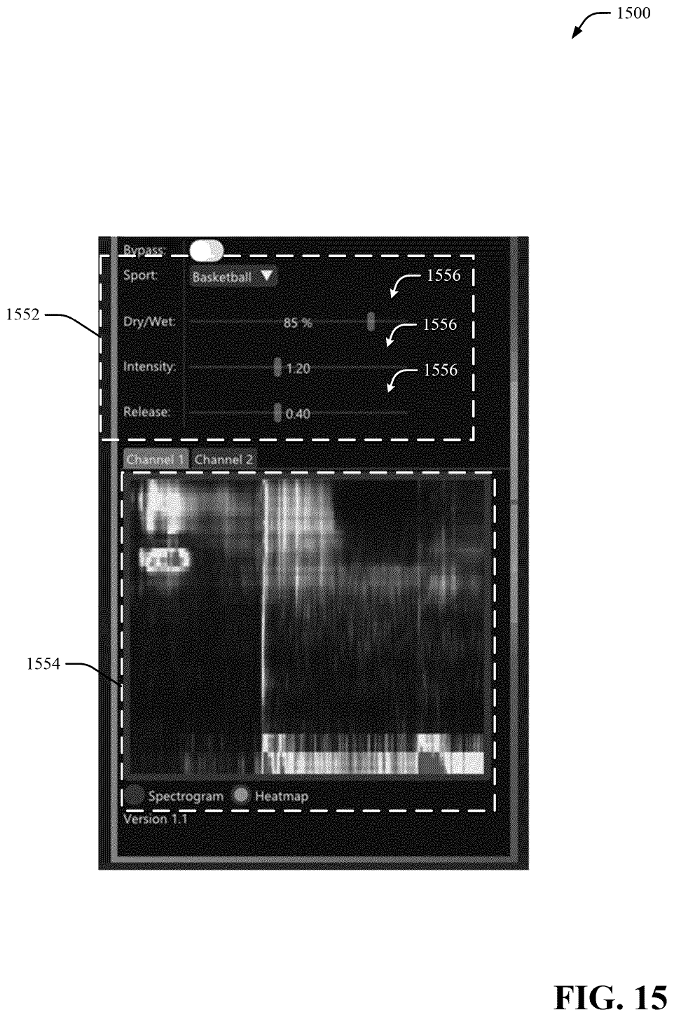

FIG. 15 illustrates an audio processing control user interface 1500 according to one or more embodiments of the present disclosure. The audio processing control user interface 1500 may be, for example, an electronic interface (e.g., a graphical user interface) of a client device (e.g., the user device 1252). For example, the audio processing control user interface 1500 may be a client device interface, a web user interface, a mobile application interface, or the like. In one or more examples, the audio processing control user interface 1500 includes a dynamic user audio isolation control interface 1552 to dynamically generate and/or modify the one or more user audio isolation control parameters 120. In one or more examples, the audio processing control user interface 1500 additionally or alternatively includes a heat map visualization 1554 to dynamically render visual data associated with the isolated audio 106 via a heat map.

In some examples, the dynamic user audio isolation control interface 1552 includes one or more user engagement interfaces 1556. In some examples, one or more user engagement interfaces 1556 may respectively be a slide control interface configured to control and/or modify a value of the one or more user audio isolation control parameters 120 for the audio stream 104. In some examples, may enable user control of intensity audio characteristics, release audio characteristics, reverberation audio characteristics, and/or one or more other audio characteristics for the isolated audio 106. In some examples, in response to a user engagement with respect to the one or more user engagement interfaces 1556, one or more control signals associated with the one or more user audio isolation control parameters 120 may be transmitted to the audio isolation signal processing system 100 via the network 1254.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

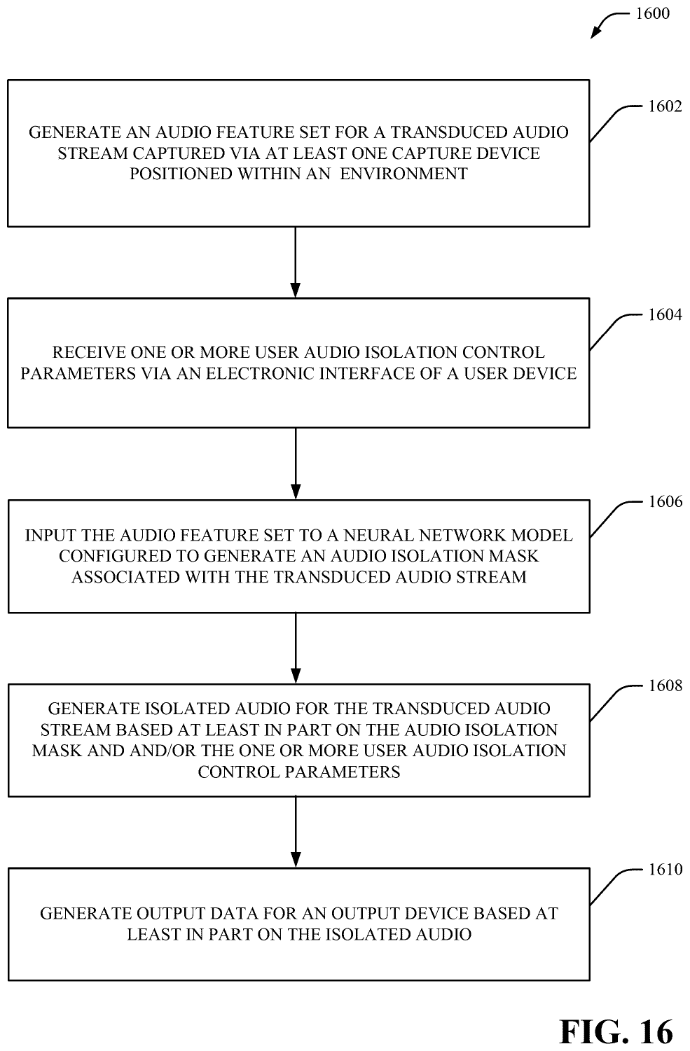

FIG. 16 is a flowchart diagram of an example process 1600, for providing audio enhancement and/or optimization of an immersive audio experience, in accordance with, for example, the audio isolation signal processing system 100 and/or the audio isolation signal processing apparatus 151. Via the various operations of the process 1600, the audio isolation signal processing system 100 and/or the audio isolation signal processing apparatus 151 may enhance audio isolation, quality, and/or reliability of an audio stream associated with an arena environment.

The process 1600 begins at operation 1602 that generates (e.g., by the ML processing circuitry 158) an audio feature set for a transduced audio stream captured via at least one capture device positioned within an environment. In some examples, the environment may define at least a first audio capture area and a second audio capture area. In some examples, the environment is an arena environment associated with a playing region, a spectator region, and/or a noise source region. In some examples, the transduced audio stream is received from an audio mixer device. In some examples, the transduced audio stream includes a first microphone signal (e.g., a commentator microphone signal) and/or one or more microphone signals associated with one or more sounds (e.g., one or more arena sounds) in the environment.

The process 1600 additionally or alternatively includes an operation 1604 that receives (e.g., by the communications circuitry 164) one or more user audio isolation control parameters via an electronic interface of a user device.

The process 1600 additionally or alternatively includes an operation 1606 that inputs (e.g., by the ML processing circuitry 158) the audio feature set to a neural network model configured to generate an audio isolation mask associated with the transduced audio stream. In some examples, the audio isolation mask includes a denoiser mask, a speech removal mask, and/or a signal of interest mask.

The process 1600 additionally or alternatively includes an operation 1608 that generates (e.g., by the DSP processing circuitry 160) isolated arena audio for the transduced audio stream based at least in part on the audio isolation mask and/or the one or more user audio isolation control parameters.

The process 1600 additionally or alternatively includes an operation 1610 that generates (e.g., by the communications circuitry 164) output data for an output device based at least in part on the isolated arena audio. In some examples, the output data includes broadcast audio. In some examples, the output data includes speech reinforcement audio. In some examples, the output data includes visual data configured to render via a display of the output device. In some examples, the output data includes a control signal for a haptic device. In some examples, beam steering associated with the at least one capture device is performed based on the audio isolation mask. In some examples, selection of an audio channel associated with desirable audio is initiated based on the audio isolation mask.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the processor, to cause the apparatus to generate a model input audio feature set for an audio stream captured via at least one capture device positioned within an arena environment defining at least one of a playing region, a spectator region, and a noise source region, wherein the at least one capture device is configured to capture transduced audio from at least one of the playing region, the spectator region, and the noise source region.

Clause 2. The apparatus of Clause 1, wherein the instructions are further operable to cause the apparatus to: input the model input audio feature set to a neural network model configured to determine at least one audio isolation mask associated with the audio stream.

Clause 3. The apparatus of any the aforementioned Clauses, wherein the instructions are further operable to cause the apparatus to: apply the at least one audio isolation mask to the audio stream to generate isolated arena audio.

Clause 4. The apparatus of any one the aforementioned Clauses, wherein the instructions are further operable to cause the apparatus to: output the isolated arena audio via an audio output device.

Clause 5. The apparatus of any the aforementioned Clauses, wherein the instructions are further operable to cause the apparatus to: input an audio signal sample associated with the audio stream to a time-frequency domain transformation pipeline of a digital signal processing process for a transformation period.

Clause 6. The apparatus of any of the aforementioned Clauses, wherein the instructions are further operable to cause the apparatus to: input the audio signal sample to a deep neural network (DNN) processing loop comprising the neural network model.

Clause 7. The apparatus of any of the aforementioned Clauses, wherein the instructions are further operable to cause the apparatus to: in a circumstance where the at least one audio isolation mask is determined prior to expiration of the transformation period, apply the at least one audio isolation mask to a frequency domain version of the audio signal sample associated with the time-frequency domain transformation pipeline to generate the isolated arena audio.

Clause 8. The apparatus of any the aforementioned Clauses, wherein the instructions are further operable to cause the apparatus to: convert the audio signal sample into a non-uniform-bandwidth frequency domain representation.

Clause 9. The apparatus of any of the aforementioned Clauses, wherein the instructions are further operable to cause the apparatus to: input the non-uniform-bandwidth frequency domain representation of the audio signal sample to the neural network model.

Clause 10. The apparatus of any the aforementioned Clauses, wherein the non-uniform-bandwidth frequency domain representation comprises a Bark scale format.

Clause 11. The apparatus of any one of clauses 8-9, wherein the non-uniform-bandwidth frequency domain representation comprises an Equivalent Rectangular Bandwidth (ERB) format

Clause 12. The apparatus of any the aforementioned Clauses, wherein the instructions are further operable to cause the apparatus to: apply post-processing to the at least one audio isolation mask to control noise cancellation related to the at least one audio isolation mask.

Clause 13. The apparatus of any the aforementioned Clauses, wherein the instructions are further operable to cause the apparatus to: input the isolated arena audio to an automixer configured to optimize audio to desired sounds in the arena environment.

Clause 14. The apparatus of any one of clauses 1-13, wherein the instructions are further operable to cause the apparatus to: perform beam steering associated with the at least one capture device based at least in part on the at least one audio isolation mask.

Clause 15. The apparatus of any the aforementioned Clauses, wherein the audio stream comprises at least one of a commentator microphone signal and one or more microphone signals associated with one or more arena sounds in the arena environment.

Clause 16. The apparatus of any the aforementioned Clauses, wherein the audio stream further comprises a reference microphone signal that drives a sound reinforcement system.

Clause 17. The apparatus of any the aforementioned Clauses, wherein the audio isolation mask comprises at least one of a denoiser mask, a speech removal mask, and a signal of interest mask.

Clause 18. The apparatus of any the aforementioned Clauses, wherein the isolated arena audio comprises broadcast audio.

Clause 19. The apparatus of any the aforementioned Clauses, wherein the isolated arena audio comprises speech reinforcement audio.

Clause 20. The apparatus of any the aforementioned Clauses, wherein the isolated arena audio is correlated with a target video stream.

Clause 21. The apparatus of any the aforementioned Clauses, wherein the arena environment is one of a basketball arena, a football stadium, a hockey stadium, a soccer stadium, a boxing arena, a concert hall, a theater, an outdoor football stadium, an outdoor baseball stadium, a soccer stadium, or a concert venue.

Clause 22. The apparatus of any the aforementioned Clauses, wherein the at least one capture device comprises a plurality of capture devices positioned within the arena environment, and wherein the plurality of capture devices are configured to direct one or more first beamformed lobes toward the playing region, one or more second beamformed lobes toward the spectator region, and one or more third beamformed lobes toward the noise source region.

Clause 23. The apparatus of any the aforementioned Clauses, wherein the isolated arena audio comprises mono audio.

Clause 24. The apparatus of any the aforementioned Clauses, wherein the isolated arena audio comprises spatial audio.

Clause 25. A computer-implemented method comprising steps related to any of the aforementioned Clauses.

Clause 26. A computer program product, stored on a computer readable medium, comprising instructions that, when executed by one or more processors of the apparatus, cause the one or more processors to perform one or more operations related to any of the aforementioned Clauses.

Clause 27. An apparatus comprising at least one processor and a memory storing instructions that are operable, when executed by the processor, to cause the apparatus to receive an audio stream captured in the arena environment, wherein the audio stream is captured via at least one capture device positioned within an arena environment defining at least one of a playing region, a spectator region, and a noise source region, wherein the at least one capture device is configured to capture transduced audio from at least one of the playing region, the spectator region, and the noise source region.

Clause 28. The apparatus of the aforementioned Clause, wherein the instructions are further operable to cause the apparatus to: input the audio stream to an audio mixer configured to generate mixed audio output and at least one audio isolation mask associated with the audio stream based on an isolated audio quality determination associated with the audio stream.

Clause 29. The apparatus of any one of clauses 27-28, wherein the instructions are further operable to cause the apparatus to: apply the at least one audio isolation mask to the mixed audio output to generate isolated arena audio.

Clause 30. The apparatus of any one of clauses 27-29, wherein the instructions are further operable to cause the apparatus to: output the isolated arena audio via an audio output device.

Clause 31. A computer-implemented method comprising steps related to any of the aforementioned Clauses.

Clause 32. A computer program product, stored on a computer readable medium, comprising instructions that, when executed by one or more processors of the apparatus, cause the one or more processors to perform one or more operations related to any of the aforementioned Clauses.

Clause 33. An apparatus comprising at least one processor and a memory storing instructions that are operable, when executed by the processor, to cause the apparatus to receive an audio stream captured via at least one capture device positioned within an arena environment defining at least one of a playing region, a spectator region, and a noise source region, wherein the at least one capture device is configured to capture transduced audio from at least one of the playing region, the spectator region, and the noise source region.

Clause 34. The apparatus of the aforementioned Clause, wherein the instructions are further operable to cause the apparatus to: input the audio stream to a digital signal processing system configured to determine audio isolation data associated with the audio stream.

Clause 35. The apparatus of any one of clauses 33-34, wherein the instructions are further operable to cause the apparatus to: modify the audio stream based on the audio isolation data to generate isolated arena audio.

Clause 36. The apparatus of any one of clauses 33-35, wherein the instructions are further operable to cause the apparatus to: output the isolated arena audio via an audio output device.

Clause 37. A computer-implemented method comprising steps related to any of the aforementioned Clauses.

Clause 38. A computer program product, stored on a computer readable medium, comprising instructions that, when executed by one or more processors of the apparatus, cause the one or more processors to perform one or more operations related to any of the aforementioned Clauses.

Clause 39. An apparatus comprising at least one processor and a memory storing instructions that are operable, when executed by the processor, to cause the apparatus to generate an audio feature set for a transduced audio stream captured via at least one capture device positioned within an environment defining at least one audio capture area.

Clause 40. The apparatus of the aforementioned Clause, wherein the instructions are further operable to cause the apparatus to: receive, from a user device, one or more user audio isolation control parameters.

Clause 41. The apparatus of any one of clauses 39-40, wherein the instructions are further operable to cause the apparatus to: input the audio feature set to a neural network model configured to generate an audio isolation mask associated with the transduced audio stream.

Clause 42. The apparatus of any the aforementioned Clauses, wherein the instructions are further operable to cause the apparatus to: generate isolated audio for the transduced audio stream based at least in part on (i) the audio isolation mask and (ii) one or more user audio isolation control parameters.

Clause 43. The apparatus of any the aforementioned Clauses, wherein the instructions are further operable to cause the apparatus to: generate output data for an output device based at least in part on the isolated audio.

Clause 44. The apparatus of any the aforementioned Clauses, wherein the environment is an arena environment.

Clause 45. The apparatus of any the aforementioned Clauses, wherein the arena environment defines a playing region, a spectator region, and a noise source region, and wherein the instructions are further operable to cause the apparatus to: generate the isolated audio for the playing region, the spectator region, or the noise source region based at least in part on (i) the audio isolation mask and (ii) the one or more user audio isolation control parameters.

Clause 46. The apparatus of any the aforementioned Clauses, wherein the instructions are further operable to cause the apparatus to: receive the transduced audio stream from an audio mixer device.

Clause 47. The apparatus of any the aforementioned Clauses, wherein the instructions are further operable to cause the apparatus to: generate mixed isolated audio based at least in part on the isolated audio and different isolated audio associated with the environment.

Clause 48. The apparatus of any the aforementioned Clauses, wherein the instructions are further operable to cause the apparatus to: generate the output data for the output device based at least in part on the mixed isolated audio.

Clause 49. The apparatus of any the aforementioned Clauses, wherein the instructions are further operable to cause the apparatus to: receive a first audio channel stream via a first capture device positioned within a first audio capture area of the environment; receive a second audio channel stream via a second capture device positioned within a second audio capture area of the environment; generate a first audio feature set for the first audio channel stream; generate a second audio feature set for the second audio channel stream; input the first audio feature set to a first neural network model to generate a first mixing control signal; input the second audio feature set to a second neural network model to generate a second mixing control signal; and/or select the transduced audio stream from a plurality of transduced audio streams based at least in part on the first mixing control signal and the second mixing control signal.

Clause 50. The apparatus of any the aforementioned Clauses, wherein the instructions are further operable to cause the apparatus to: select the transduced audio stream via an audio mixer device.

Clause 51. The apparatus of any the aforementioned Clauses, wherein the instructions are further operable to cause the apparatus to: input an audio signal sample associated with the transduced audio stream to a time-frequency domain transformation pipeline of a digital signal processing process for a transformation period; input the audio signal sample to a deep neural network (DNN) processing loop comprising the neural network model; and/or based on the audio isolation mask being determined prior to expiration of the transformation period, apply the audio isolation mask to a frequency domain version of the audio signal sample associated with the time-frequency domain transformation pipeline to generate the isolated audio.

Clause 52. The apparatus of any the aforementioned Clauses, wherein the instructions are further operable to cause the apparatus to: generate a reference audio feature set for a reference microphone signal associated with the environment.

Clause 53. The apparatus of any the aforementioned Clauses, wherein the instructions are further operable to cause the apparatus to: input the audio feature set and the reference audio feature set to the neural network model to generate the audio isolation mask.

Clause 54. The apparatus of any the aforementioned Clauses, wherein the transduced audio stream comprises at least one microphone signal from a group comprising a first microphone signal and one or more microphone signals associated with one or more sounds in the environment.

Clause 55. The apparatus of any the aforementioned Clauses, wherein the audio isolation mask comprises a denoiser mask, a speech removal mask, or a signal of interest mask.

Clause 56. The apparatus of any the aforementioned Clauses, wherein the output data comprises broadcast audio.

Clause 57. The apparatus of any the aforementioned Clauses, wherein the output data comprises speech reinforcement audio.

Clause 58. The apparatus of any the aforementioned Clauses, wherein the output data comprises visual data configured to render via a display of the output device.

Clause 59. The apparatus of any the aforementioned Clauses, wherein the output device is a haptic device, and/or wherein the output data comprises a control signal for the haptic device.

Clause 60. The apparatus of any the aforementioned Clauses, wherein the output data comprises a video stream associated with the isolated audio.

Clause 61. The apparatus of any the aforementioned Clauses, wherein the instructions are further operable to cause the apparatus to: perform beam steering associated with the at least one capture device based at least in part on the audio isolation mask.

Clause 62. The apparatus of any the aforementioned Clauses, wherein the instructions are further operable to cause the apparatus to: initiate selection of an audio channel associated with desirable audio based at least in part on the audio isolation mask.

Clause 63. A computer-implemented method comprising steps related to any of the aforementioned Clauses.

Clause 64. A computer program product, stored on a computer readable medium, comprising instructions that, when executed by one or more processors of the apparatus, cause the one or more processors to perform one or more operations related to any of the aforementioned Clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and a memory storing instructions that are operable, when executed by the at least one processor, to cause the apparatus to:
generate an audio feature set for a transduced audio stream captured via at least one capture device positioned within an environment defining at least one audio capture area;
receive, from a user device, one or more user audio isolation control parameters;
input the audio feature set to a neural network model configured to generate an audio isolation mask associated with the transduced audio stream;
generate isolated audio for the transduced audio stream based at least in part on (i) the audio isolation mask and (ii) one or more user audio isolation control parameters; and
generate output data for an output device based at least in part on the isolated audio.

2. The apparatus of claim 1, wherein the environment is an arena environment.

3. The apparatus of claim 2, wherein the arena environment defines a playing region, a spectator region, and a noise source region, and wherein the instructions are further operable to cause the apparatus to:
generate the isolated audio for the playing region, the spectator region, or the noise source region based at least in part on (i) the audio isolation mask and (ii) the one or more user audio isolation control parameters.

4. The apparatus of claim 1, wherein the instructions are further operable to cause the apparatus to:
receive the transduced audio stream from an audio mixer device.

5. The apparatus of claim 1, wherein the instructions are further operable to cause the apparatus to:
generate mixed isolated audio based at least in part on the isolated audio and different isolated audio associated with the environment; and
generate the output data for the output device based at least in part on the mixed isolated audio.

6. The apparatus of claim 1, wherein the instructions are further operable to cause the apparatus to:
receive a first audio channel stream via a first capture device positioned within a first audio capture area of the environment;
receive a second audio channel stream via a second capture device positioned within a second audio capture area of the environment;
generate a first audio feature set for the first audio channel stream;
generate a second audio feature set for the second audio channel stream;
input the first audio feature set to a first neural network model to generate a first mixing control signal;
input the second audio feature set to a second neural network model to generate a second mixing control signal; and
select the transduced audio stream from a plurality of transduced audio streams based at least in part on the first mixing control signal and the second mixing control signal.

7. The apparatus of claim 6, wherein the instructions are further operable to cause the apparatus to:
select the transduced audio stream via an audio mixer device.

8. The apparatus of claim 1, wherein the instructions are further operable to cause the apparatus to:
input an audio signal sample associated with the transduced audio stream to a time-frequency domain transformation pipeline of a digital signal processing process for a transformation period;
input the audio signal sample to a deep neural network (DNN) processing loop comprising the neural network model; and
based on the audio isolation mask being determined prior to expiration of the transformation period, apply the audio isolation mask to a frequency domain version of the audio signal sample associated with the time-frequency domain transformation pipeline to generate the isolated audio.

9. The apparatus of claim 1, wherein the instructions are further operable to cause the apparatus to:
generate a reference audio feature set for a reference microphone signal associated with the environment; and
input the audio feature set and the reference audio feature set to the neural network model to generate the audio isolation mask.

10. The apparatus of claim 1, wherein the transduced audio stream comprises at least one microphone signal from a group comprising a first microphone signal and one or more microphone signals associated with one or more sounds in the environment.

11. The apparatus of claim 1, wherein the audio isolation mask comprises a denoiser mask, a speech removal mask, or a signal of interest mask.

12. The apparatus of claim 1, wherein the output data comprises broadcast audio.

13. The apparatus of claim 1, wherein the output data comprises speech reinforcement audio.

14. The apparatus of claim 1, wherein the output data comprises visual data configured to render via a display of the output device.

15. The apparatus of claim 1, wherein the output device is a haptic device, and wherein the output data comprises a control signal for the haptic device.

16. The apparatus of claim 1, wherein the output data comprises a video stream associated with the isolated audio.

17. The apparatus of claim 1, wherein the instructions are further operable to cause the apparatus to:
perform beam steering associated with the at least one capture device based at least in part on the audio isolation mask.

18. The apparatus of claim 1, wherein the instructions are further operable to cause the apparatus to:
initiate selection of an audio channel associated with desirable audio based at least in part on the audio isolation mask.

19. A computer-implemented method comprising:
generating an audio feature set for a transduced audio stream captured via at least one capture device positioned within an environment defining at least one audio capture area;
inputting the audio feature set to a neural network model configured to generate an audio isolation mask associated with the transduced audio stream;
generating isolated audio for the transduced audio stream based at least in part on (i) the audio isolation mask and (ii) one or more user audio isolation control parameters; and
generating output data for an output device based at least in part on the isolated audio.

20. A computer program product, stored on a computer readable medium, comprising instructions that, when executed by one or more processors of an apparatus, cause the one or more processors to:
generate an audio feature set for a transduced audio stream captured via at least one capture device positioned within an environment defining at least one audio capture area;
input the audio feature set to a neural network model configured to generate an audio isolation mask associated with the transduced audio stream;
generate isolated audio for the transduced audio stream based at least in part on (i) the audio isolation mask and (ii) one or more user audio isolation control parameters; and
generate output data for an output device based at least in part on the isolated audio.
